(19) United States
(12) Patent Application Publication
(10) Pub. No.: US 2026/0133635 A1
(43) Pub. Date: May 14, 2026

(54) In-Ear Brain-Computer Interfaces

(71) Applicant: Neurable Inc., Boston, MA (US)

(72) Inventors: Jamie Alders, Boston, MA (US); David Stanley, Boston, MA (US)

(21) Appl. No.: 19/385,081

(22) Filed: Nov. 10, 2025

Related U.S. Application Data
(63) Continuation of application No. PCT/US2025/054607, filed on Nov. 7, 2025.
(60) Provisional application No. 63/718,735, filed on Nov. 10, 2024.
(60) Provisional application No. 63/718,735, filed on Nov. 10, 2024.

(51) Int. Cl. G06F 3/01

(52) U.S. Cl. CPC G06F 3/015

(57) ABSTRACT

Systems and methods for implementing in-ear brain-computer interfaces are described. For example, a method may include accessing measurements of electrical potential of a first electrode, a second electrode, and a third electrode that are in contact with an inside surface of an ear canal; determining a reference signal based on measurements of electrical potential of the first electrode; determining a ground signal based on measurements of electrical potential of the second electrode; determining a first electroencephalography signal based on measurements of electrical potential of the third electrode and based on the reference signal; and estimating a brain state based on the first electroencephalography signal.

### CROSS REFERENCE TO RELATED APPLICATION(S)

This application is a continuation of International Application No. PCT/US 2025/054607, filed on Nov. 7, 2025, which claims the benefit of U.S. Provisional Ser. No. 63/718,735 filed on Nov. 10, 2024, the contents of which are incorporated by reference herein.

### TECHNICAL FIELD

This disclosure relates to in-ear brain-computer interfaces.

### BACKGROUND

A brain-computer interface (BCI) is a direct communication link between the brain's electrical activity and an external device, most commonly a computer or robotic limb. BCIs are often directed at researching, mapping, assisting, augmenting, or repairing human cognitive or sensory-motor functions. BCI implementations range from non-invasive (e.g., using Electroencephalography (EEG), Magnetoencephalography (MEG), or Magnetic resonance imaging (MRI)) and partially invasive (e.g., using Electrocorticography (ECoG) or endovascular) to invasive (e.g., using a microelectrode array), based on how physically close electrodes are to brain tissue.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-E are illustrations of an example of a system including an in-ear brain-computer interface with a single eartip.

FIGS. 2A-E are illustrations of an example of a system including an in-ear brain-computer interface with two eartips and one electroencephalography channel per ear.

FIGS. 3A-E are illustrations of an example of a system including an in-ear brain-computer interface with two eartips and two electroencephalography channels per ear.

FIGS. 4A-E are illustrations of an example of an eartip with four electrodes.

FIGS. 5A-C are illustrations of an example of a system including an in-ear brain-computer interface with wireless earbud devices in communication with a smart charging case.

FIG. 6A is a block diagram of an example of a system including an in-ear brain-computer interface.

FIG. 6B is a block diagram of an example of a system including an in-ear brain-computer interface.

FIG. 7 is flowchart of an example of a technique for providing an in-ear brain-computer interface.

FIG. 8 is flowchart of an example of a technique for suppressing common mode noise in one or more electroencephalography channels of an in-ear brain-computer interface.

FIG. 9 is flowchart of an example of a technique for adding an additional electroencephalography channel in an in-ear brain-computer interface.

FIG. 10 is flowchart of an example of a technique for identifying artifacts in an electroencephalography signal caused by motion of an eartip using a contact microphone.

FIG. 11 is flowchart of an example of a technique for identifying artifacts in an electroencephalography signal caused by motion of an eartip using an accelerometer.

FIG. 12 is flowchart of an example of a technique for identifying artifacts in an electroencephalography signal caused by motion of an eartip using a gyroscope.

FIG. 13 is a signal flow diagram of an example of a signal flow in an in-ear brain-computer interface.

FIG. 14 is a signal flow diagram of an example of an electroencephalography signal processing pipeline in an in-ear brain-computer interface.

### DETAILED DESCRIPTION

Systems and methods for providing in-ear brain-computer interfaces are disclosed. An arrangement of electrodes on eartip attachment to an earbud device may be used to position a first electrode, a second electrode and a third electrode in contact with an inside surface (i.e., skin) of an ear canal. Measurements of electrical potential of the first electrode, the second electrode, and the third electrode are processed to determine a reference signal based on measurements of electrical potential of the first electrode, determine a ground signal (e.g., an active ground signal) based on measurements of electrical potential of the second electrode, and determine a first electroencephalography signal based on measurements of electrical potential of the third electrode and based on the reference signal. A brain state may be estimated based on the first electroencephalography signal. For example, the estimated brain state may include a vector of features (e.g., power spectral density in alpha (8-12 Hz), beta (12-30 Hz), theta (4-8 Hz), gamma (30-100 Hz), and/or Delta (1-4 Hz) frequency ranges) determined based on the first electroencephalography signal and/or a vector of brain state predictions generated using machine learning models trained to output predictions correlated with certain aspects of a brain state (e.g., correlated with a level of focus, a level of attentiveness, a level of cognitive load, fatigue, or sleepiness) based on the a window of samples from the first electroencephalography signal and/or based on the vector of features.

Systems may include driven-right-leg (DRL) circuitry configured to apply a voltage signal to skin the ear canal via the second electrode to suppress common mode noise in the first electroencephalography signal.

Additional electrodes may be used to generate additional channels of electroencephalography data. One or more such additional electrodes may be positioned in contact with the skin of the ear canal. In some implementations, all electrodes used to measure electroencephalography signals that are in turn used to determine the estimate of brain state are exclusively positioned within the ear canal during operation of the in-ear brain computer interface. In other implementations, additional electrodes for measuring electroencephalography signals may be positioned elsewhere on the skin of the user.

As used herein, the term “circuitry” refers to an arrangement of electronic components (e.g., transistors, resistors, capacitors, and/or inductors) that is structured to implement one or more functions. For example, a circuitry may include one or more transistors interconnected to form logic gates that collectively implement a logical function.

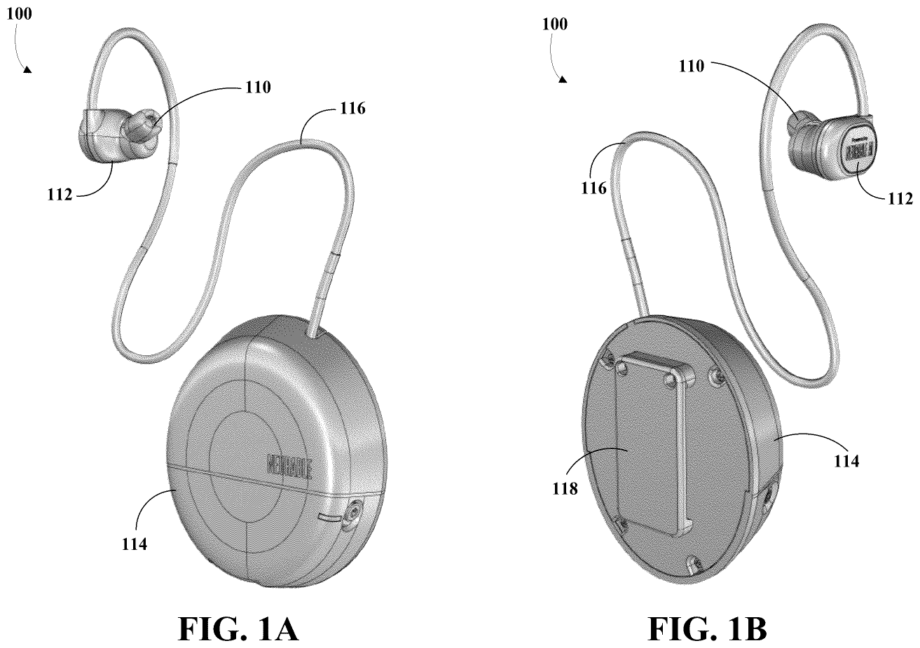

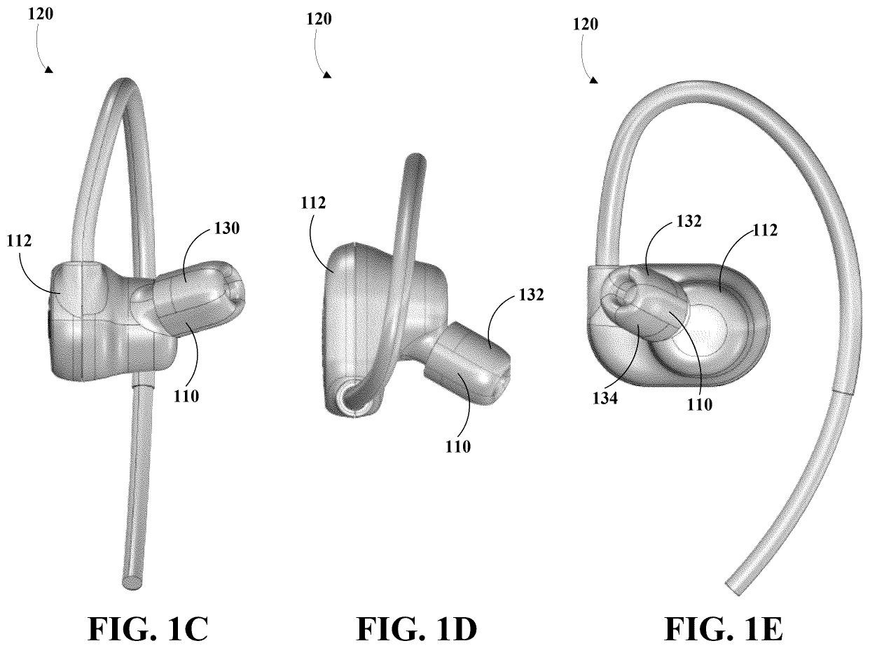

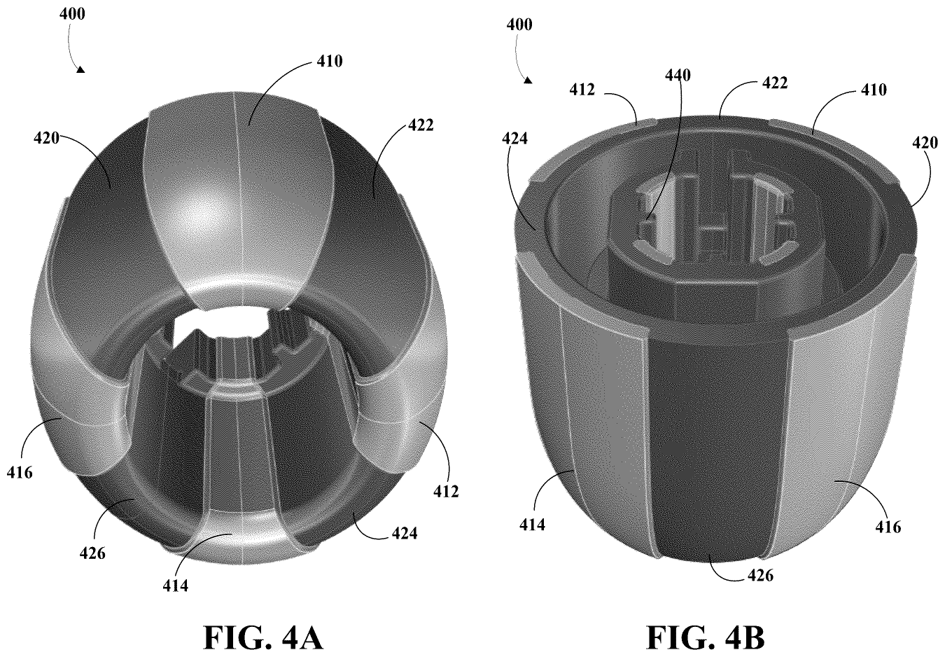

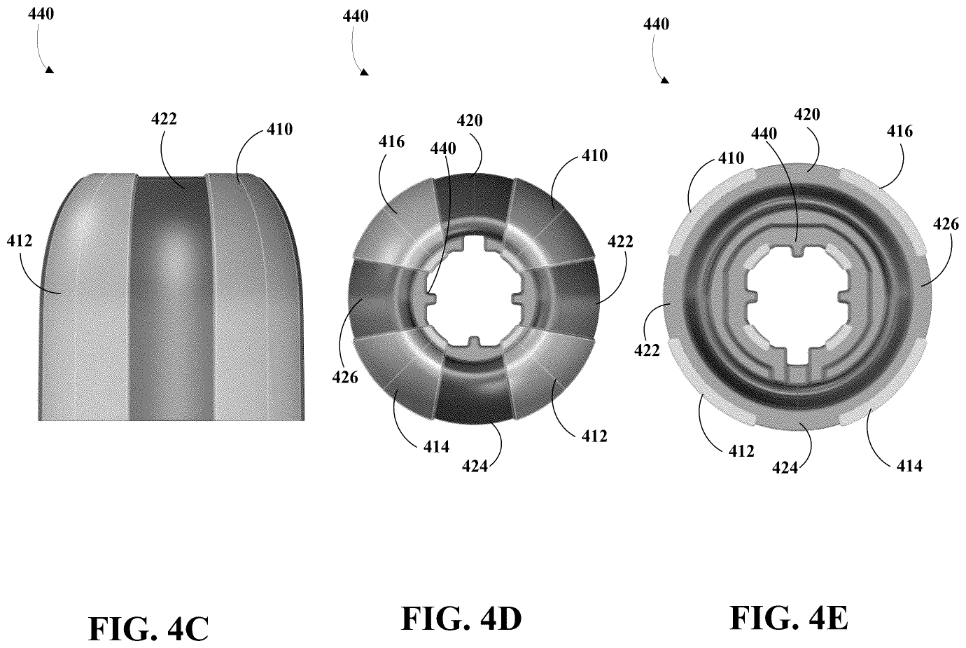

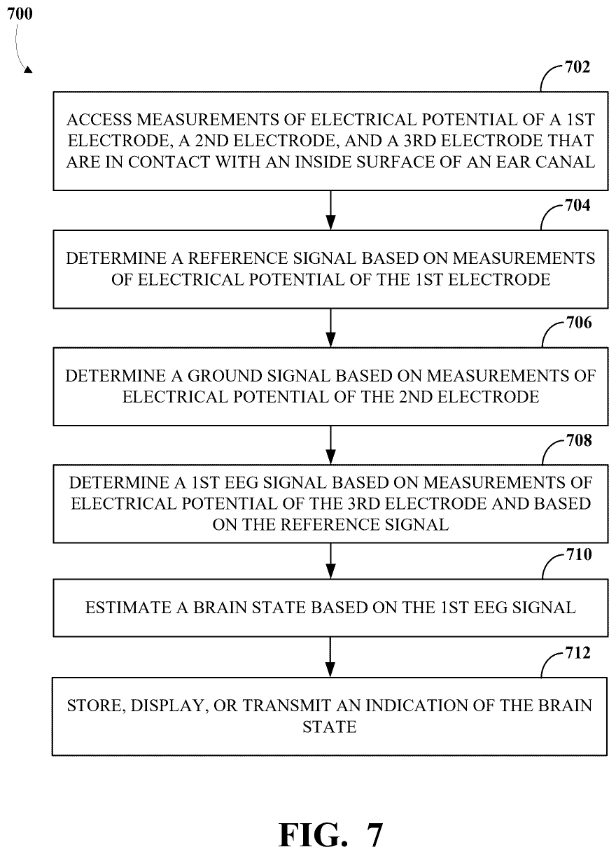

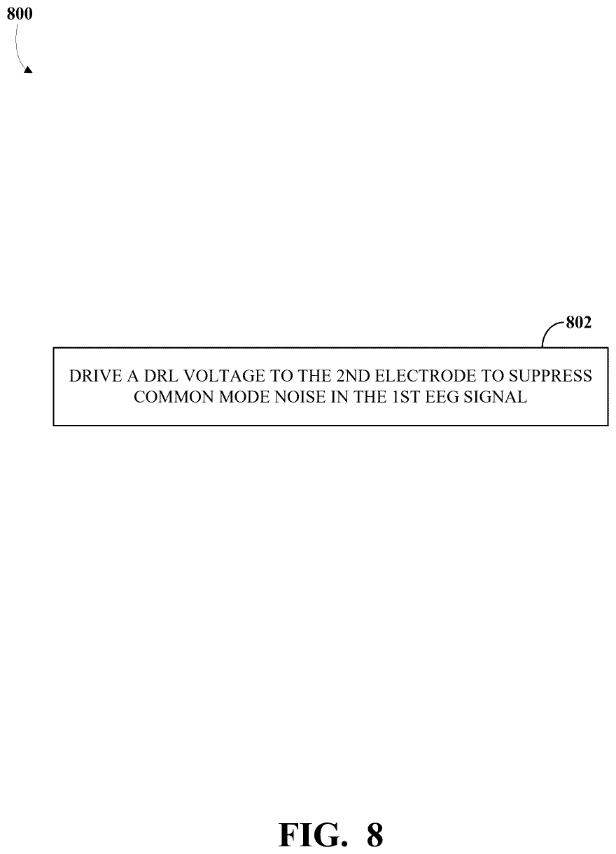

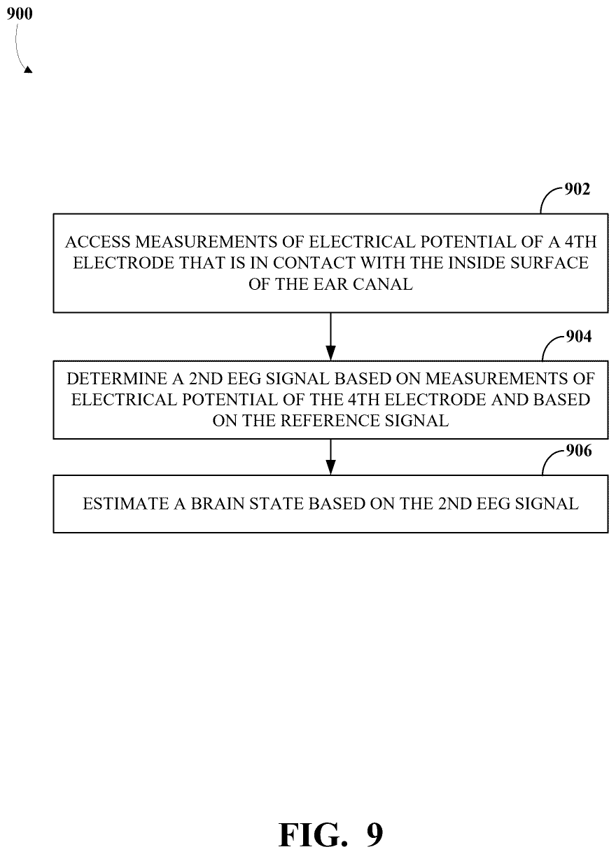

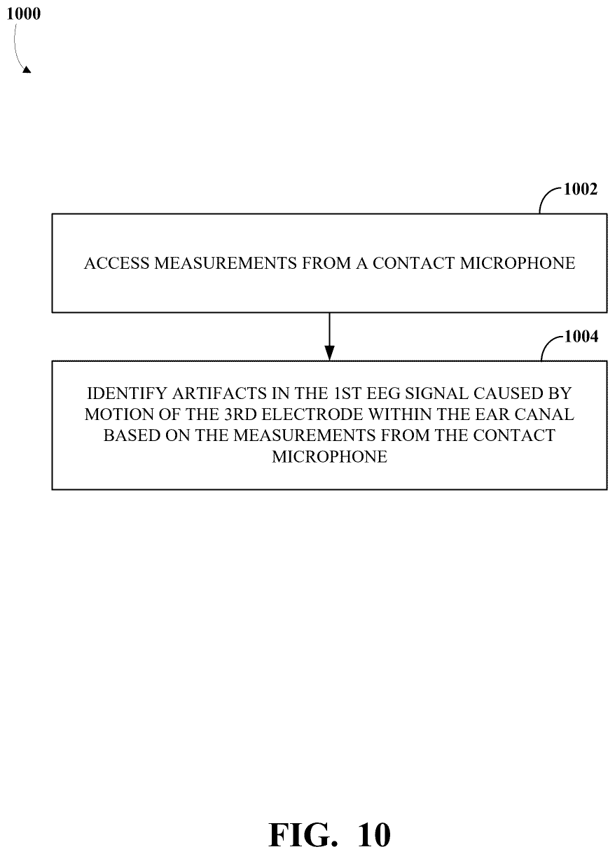

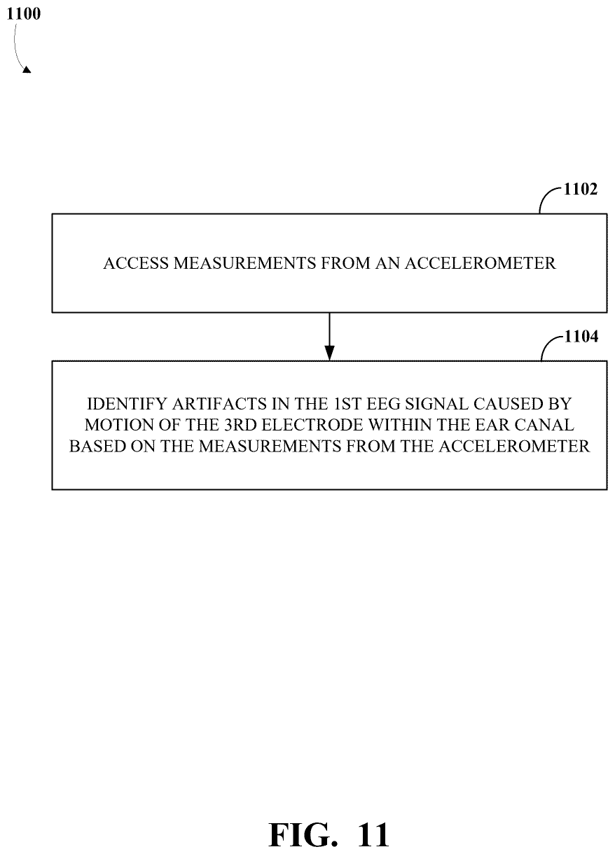

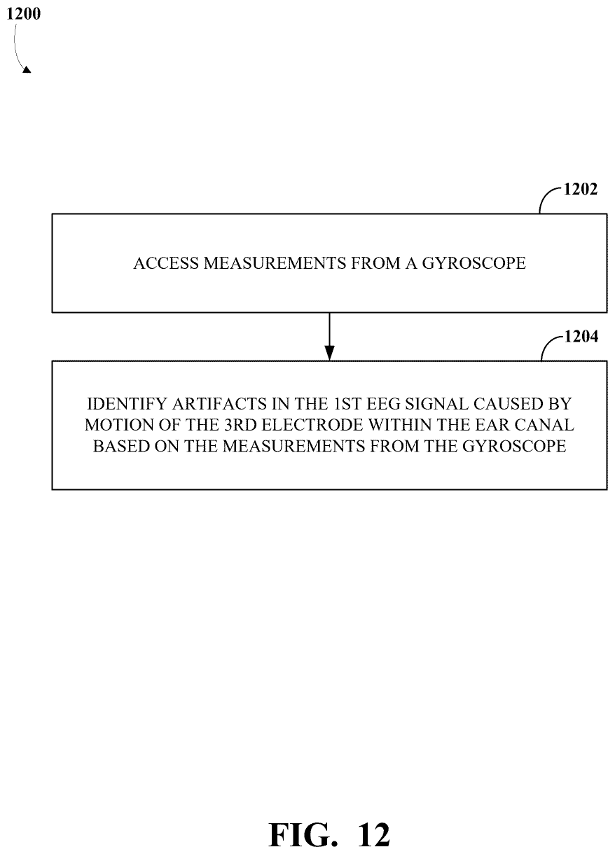

FIGS. 1A-E are illustrations of an example of a system 100 including an in-ear brain-computer interface with a single eartip. The system 100 includes an eartip 110 shaped for insertion in an ear canal. The system 100 includes three electrodes (e.g., a first electrode, a second electrode, and a third electrode) positioned on one or more outer surfaces of the eartip 110. For example, the eartip 110 may be similar in structure to the eartip 400 of FIG. 4A. For example, these three electrodes may respectively be used as a common reference electrode, a ground/driven right leg (DRL) electrode, and a first electroencephalography channel electrode. Measurements of electrical potential of theses electrodes while the eartip 110 is inserted in an ear canal may be used to determine a reference signal, a ground signal, and a first electroencephalography signal. The first electroencephalography signal may be determined as a voltage relative to the reference signal. The first electroencephalography signal may be used to estimate a brain state (e.g., by generating a focus score or some other metric of brain waves detected in the first electroencephalography signal). For example, the system 100 may be used to implement the technique 700 of FIG. 7. For example, the system 100 may be used to implement the technique 800 of FIG. 8. For example, the system 100 may be used to implement the technique 900 of FIG. 9. For example, the system 100 may be used to implement the technique 1000 of FIG. 10. For example, the system 100 may be used to implement the technique 1100 of FIG. 11. For example, the system 100 may be used to implement the technique 1200 of FIG. 12.

The eartip 110 is attached to an earbud device 112 that includes a speaker (e.g., for playing music or other sounds for a user wearing the earbud device 112). The system 100 also includes a personal computing device 114 that is connected to the earbud device 112 via a cable 116. For example, the cable 116 may include conductors that may be used to transmit power from the personal computing device 114 to the earbud device 112 and/or to transmit data between the personal computing device 114 and the earbud device 112 (e.g., using a serial port communications protocol, such as Universal Serial Bus (USB), Inter-Integrated Circuit (I²C) or Serial Peripheral Interface (SPI)). In this example, the personal computing device 114 is a controller module that includes a clip 118 to facilitate a user wearing the personal computing device 114 (e.g., clipped to a belt or a pocket of their clothing). In some implementations, the earbud device 112 includes an array of microphones configured for use with the speaker to cancel noise.

FIGS. 1C-E are enlarged illustrations of components 120 of the system 100 from various perspectives, which include views of the three electrodes on an outer surface of the eartip 110. For example, the main body of the eartip 110 may be made of a flexible material that is an electrical insulator, such as, for example, silicone or rubber. The system 100 includes a first electrode 130 positioned on an outer surface of the eartip 110, a second electrode 132 positioned on an outer surface of the eartip 110, a third electrode 134 positioned on an outer surface of the eartip 110. In the example of FIGS. 1A-E, the three electrodes (130, 132, and 134) are all positioned on a same outer surface of the eartip 110, but in other examples, where an eartip includes multiple outer surfaces configured to come in contact with skin in an ear canal when the eartip 110 is inserted in the ear canal, the three electrodes (130, 132, and 134) may be positioned on different outer surfaces of the eartip 110. The first electrode 130, the second electrode 132, and the third electrode 134 may each include an electrically conductive strip and may be coated with a conductive polymer (e.g., polyacetylene or polypyrrole). For example, the first electrode 130, the second electrode 132, and the third electrode 134 may each include metal foil and/or conductive fabric.

In this example, the first electrode 130, the second electrode 132, and the third electrode 134 extend laterally along the eartip 110 from an anterior end of the eartip 110 that will be inserted deepest into the ear canal to a posterior end of the eartip 110. One or more of the electrodes (e.g., the third electrode 134) may be sized to fit entirely inside the ear canal. In this example, the eartip 110 has a cylindrical outer surface and the first electrode 130, the second electrode 132, and the third electrode 134 are positioned around the cylindrical outer surface with strips of insulator (e.g., strips of the main body of the eartip 110) on the cylindrical outer surface separating the first electrode 130, the second electrode 132, and the third electrode 134. In some implementations, an outer surface of the eartip 110 has an oval cross section perpendicular to axis of insertion into the ear canal. The eccentricity of the cross section of the eartip 110 may serve to fit more snugly in an ear canal and prevent or reduce rotation of the eartip 110 within the ear canal during use.

The eartip 110 may be an easily replaceable component of the earbud device 112. For example, system 100 may include multiple replaceable eartips of different sizes to better fit the ear canal of a particular user. In some implementations, the eartip 110 is removably attached to an earbud device 112 using a mechanical interface that includes a rotation locking mechanism configured to prevent rotation of the eartip 110 about an axis of insertion into the ear canal. This rotation locking mechanism may serve to prevent or reduce movement of the electrodes (130, 132, and 134) with respect to the electrical contacts on the earbud device 312 during use.

In some implementations, the system 100 includes circuitry configured to drive a driven right leg (DRL) voltage to the second electrode 132 to suppress common mode noise in the first electroencephalography signal. For example, circuitry configured to drive a DRL voltage on the second electrode 132 may be located in the earbud device 112 and/or may include logic or processor or microcontroller components located in the personal computing device 114.

The system 100 may also include one or more sensors for detecting motion of the earbud with respect to the ear canal during use that can cause artifacts in the first electroencephalography signal, which may enable the cancellation or suppression of these artifacts in the electroencephalography signal to improve signal to noise ratio (SNR) of the electroencephalography signal. For example, the system 100 may include a contact microphone positioned near an anterior end of the eartip 110 (e.g., positioned in the earbud device 112). For example, the system 100 may include an accelerometer positioned near an anterior end of the eartip 110 (e.g., positioned in the earbud device 112). For example, the system 100 may include a gyroscope (e.g., a microelectromechanical systems (MEMS) gyroscope) positioned near an anterior end of the eartip 110 (e.g., positioned in the earbud device 112).

In some implementations, the system uses only electrodes that are positioned inside an ear canal during use to detect electroencephalography signals used to estimate brain states and provide a brain-computer interface. For example, in some implementations, all electrodes on outer surfaces of the earbud device 112 are positioned on the eartip 110 to fit within the ear canal.

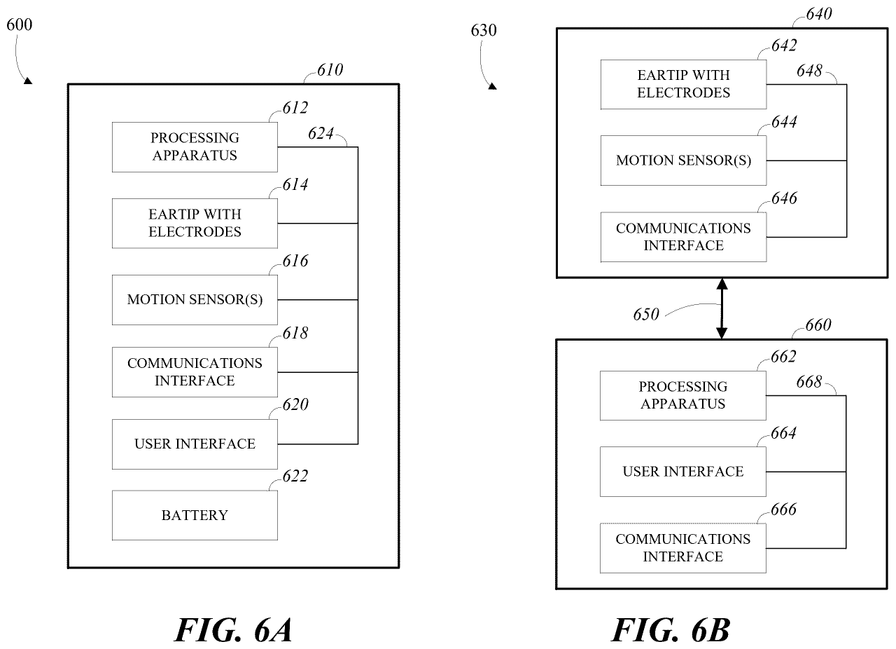

The system 100 includes a processing apparatus, which may be distributed between the personal computing device 114 and/or the earbud device 112. The processing apparatus may include one or more processors having single or multiple processing cores. The processing apparatus may include memory, such as random access memory device (RAM), flash memory, or any other suitable type of storage device such as a non-transitory computer readable memory. The memory of the processing apparatus may include executable instructions and data that can be accessed by one or more processors of the processing apparatus. For example, the processing apparatus may include the processing apparatus 612 of FIG. 6A. For example, the processing apparatus may include the processing apparatus 662 of FIG. 6B. In some implementations, the processing apparatus also includes one more processors (e.g., of a laptop computer or a cloud server) in communication with a processor of the personal computing device 114 via wireless network communication protocols (e.g., Bluetooth or WiFi). In some implementations, the electrodes (e.g., the third electrode 234) are connected to the processing apparatus via one or more conductors connected in series (e.g., including a conductor of the cable 116).

The processing apparatus of the system 100 may be configured to access measurements of electrical potential of the first electrode, the second electrode, and the third electrode; determine a reference signal based on measurements of electrical potential of the first electrode; determine a ground signal (e.g., an active ground signal) based on measurements of electrical potential of the second electrode; and determine a first electroencephalography signal based on measurements of electrical potential of the third electrode and based on the reference signal. The processing apparatus of the system 100 may be configured to estimate a brain state (e.g., a focus score) based on the first electroencephalography signal.

In some implementations, where the system 100 includes one or more sensors for detecting motion of the earbud with respect to the ear canal during use that can cause artifacts in the first electroencephalography signal, the processing apparatus may be configured to access measurements from a contact microphone, and identify artifacts in the first electroencephalography signal caused by motion of the eartip 110 within the ear canal based on the measurements from the contact microphone. For example, the processing apparatus may be configured to access measurements from an accelerometer, and identify artifacts in the first electroencephalography signal caused by motion of the eartip 110 within the ear canal based on the measurements from the accelerometer. For example, the processing apparatus may be configured to access measurements from a gyroscope, and identify artifacts in the first electroencephalography signal caused by motion of the eartip 110 within the ear canal based on the measurements from the gyroscope.

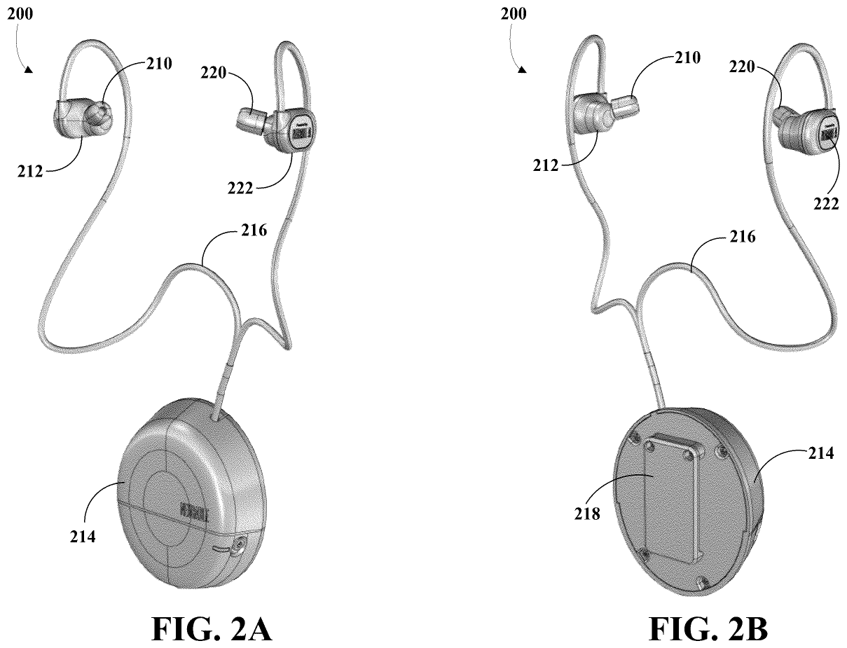

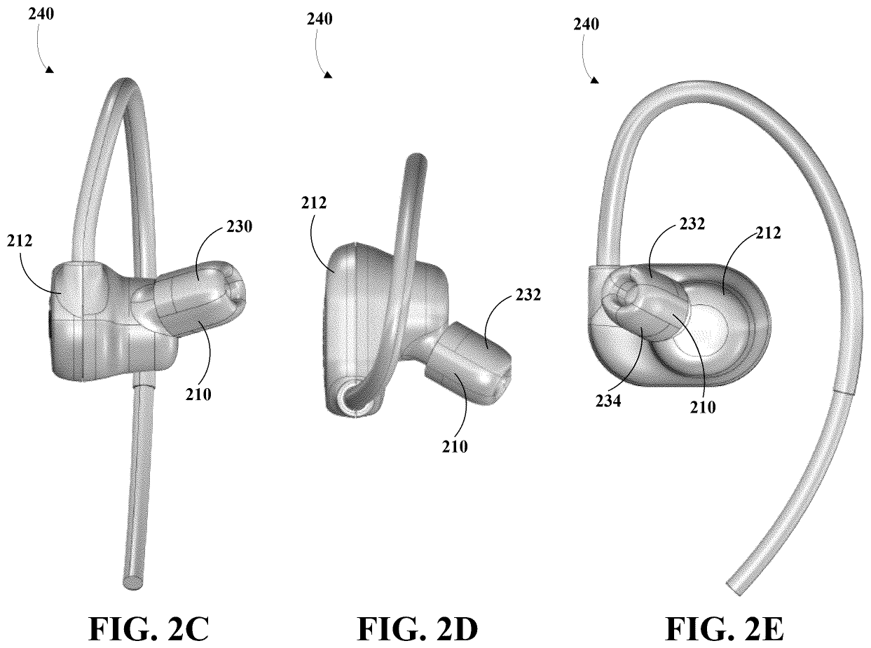

FIGS. 2A-E are illustrations of an example of a system 200 including an in-ear brain-computer interface with two eartips and one electroencephalography channel per ear. The system 200 includes a first eartip 210 shaped for insertion in an ear canal and a second eartip 220 shaped for insertion in an ear canal. The system 200 includes three electrodes (e.g., a first electrode, a second electrode, and a third electrode) positioned on one or more outer surfaces of the first eartip 210. For example, the first eartip 210 may be similar in structure to the eartip 400 of FIG. 4A. The system 200 includes three electrodes (e.g., a fourth electrode, a fifth electrode, and a sixth electrode) positioned on one or more outer surfaces of the second eartip 220. For example, the second eartip 220 may be similar in structure to the eartip 400 of FIG. 4A. For example, these three electrodes on each eartip may respectively be used as common reference electrode, a ground/driven right leg (DRL) electrode, and an electroencephalography channel electrode. Measurements of electrical potential of theses electrodes while the eartips 210 and 220 are inserted in their respective ear canals of a user may be used to determine a reference signal, a ground signal, and an electroencephalography signal from each ear. The electroencephalography signals may be determined as a voltage relative to their reference signals in the same ear canal. The electroencephalography signals may be used to estimate a brain state (e.g., by generating a focus score or some other metric of brain waves detected in the electroencephalography signals). For example, the system 200 may be used to implement the technique 700 of FIG. 7. For example, the system 200 may be used to implement the technique 800 of FIG. 8. For example, the system 200 may be used to implement the technique 900 of FIG. 9. For example, the system 200 may be used to implement the technique 1000 of FIG. 10. For example, the system 200 may be used to implement the technique 1100 of FIG. 11. For example, the system 200 may be used to implement the technique 1200 of FIG. 12.

The first eartip 210 is attached to a first earbud device 212 that includes a speaker (e.g., for playing music or other sounds for a user wearing the earbud device 212). The second eartip 220 is attached to a second earbud device 222 that includes a speaker. The system 200 also includes a personal computing device 214 that is connected to the earbud device 212 via a cable 216. For example, the cable 216 may include conductors that may be used to transmit power from the personal computing device 214 to the first earbud device 212 and the second earbud device 222, and/or used to transmit data between the personal computing device 214 and the first earbud device 212 and the second earbud device 222 (e.g., using a serial port communications protocol, such as Universal Serial Bus (USB), Inter-Integrated Circuit (I²C) or Serial Peripheral Interface (SPI)). In this example, the personal computing device 214 is a controller module that includes a clip 218 to facilitate a user wearing the personal computing device 214 (e.g., clipped to a belt or a pocket of their clothing). In some implementations, the first earbud device 212 and the second earbud device 222 include an array of microphones configured for use with the speakers to cancel noise.

FIGS. 2C-E are enlarged illustrations of components 240 of the system 200 from various perspectives, which include views of the three electrodes on an outer surface of the first eartip 210. For example, the main body of the first eartip 210 may be made of a flexible material that is an electrical insulator, such as, for example, silicone or rubber. The system 200 includes a first electrode 230 positioned on an outer surface of the first eartip 210, a second electrode 232 positioned on an outer surface of the first eartip 210, a third electrode 234 positioned on an outer surface of the first eartip 210. In the example of FIGS. 2A-E, the three electrodes (230, 232, and 234) are all positioned on a same outer surface of the first eartip 210, but in other examples, where an eartip includes multiple outer surfaces configured to come in contact with skin in an ear canal when the first eartip 210 is inserted in the ear canal, the three electrodes (230, 232, and 234) may be positioned on different outer surfaces of the first eartip 210. The first electrode 230, the second electrode 232, and the third electrode 234 may each include an electrically conductive strip and may be coated with a conductive polymer (e.g., polyacetylene or polypyrrole). For example, the first electrode 230, the second electrode 232, and the third electrode 234 may each include metal foil and/or conductive fabric.

In this example, the first electrode 230, the second electrode 232, and the third electrode 234 extend laterally along the first eartip 210 from an anterior end of the first eartip 210 that will be inserted deepest into the ear canal to a posterior end of the first eartip 210. One or more of the electrodes (e.g., the third electrode 234) may be sized to fit entirely inside the ear canal. In this example, the first eartip 210 has a cylindrical outer surface and the first electrode 230, the second electrode 232, and the third electrode 234 are positioned around the cylindrical outer surface with strips of insulator (e.g., strips of the main body of the first eartip 210) on the cylindrical outer surface separating the first electrode 230, the second electrode 232, and the third electrode 234. In some implementations, an outer surface of the first eartip 210 has an oval cross section perpendicular to axis of insertion into the ear canal. The eccentricity of the cross section of the first eartip 210 may serve to fit more snugly in an ear canal and prevent or reduce rotation of the first eartip 210 within the ear canal during use.

The first eartip 210 and the second eartip 220 may be an easily replaceable components of the first earbud device 212 and the second earbud device 222 respectively. For example, system 200 may include multiple replaceable eartips of different sizes to better fit the ear canal of a particular user. In some implementations, the first eartip 210 is removably attached to the first earbud device 212 using a mechanical interface that includes a rotation locking mechanism configured to prevent rotation of the first eartip 210 about an axis of insertion into the ear canal. This rotation locking mechanism may serve to prevent or reduce movement of the electrodes (230, 232, and 234) with respect to the electrical contacts on the earbud device 312 during use.

In some implementations, the system 200 includes circuitry configured to drive a driven right leg (DRL) voltage to the second electrode 232 to suppress common mode noise in the first electroencephalography signal. For example, circuitry configured to drive a DRL voltage on the second electrode 232 may be located in the first earbud device 212 and/or may include logic or processor or microcontroller components located in the personal computing device 214.

The system 200 may also include one or more sensors for detecting motion of the earbuds with respect to the ear canal they are in during use that can cause artifacts in the electroencephalography signals from the ear canals, which may enable the cancellation or suppression of these artifacts in the electroencephalography signals to improve signal to noise ratio (SNR) of the electroencephalography signals. For example, the system 200 may include a contact microphone positioned near an anterior end of the first eartip 210 (e.g., positioned in the first earbud device 212). For example, the system 200 may include an accelerometer positioned near an anterior end of the first eartip 210 (e.g., positioned in the first earbud device 212). For example, the system 200 may include a gyroscope (e.g., a microelectromechanical systems (MEMS) gyroscope) positioned near an anterior end of the first eartip 210 (e.g., positioned in the first earbud device 212).

In some implementations, the system uses only electrodes that are positioned inside an ear canal during use to detect electroencephalography signals used to estimate brain states and provide a brain-computer interface. For example, in some implementations, all electrodes on outer surfaces of the first earbud device 212 are positioned on the first eartip 210 to fit within an ear canal, and all electrodes on outer surfaces of the second earbud device 222 are positioned on the second eartip 220 to fit within a second ear canal.

The system 200 includes a processing apparatus, which may be distributed between the personal computing device 214 and/or the first earbud device 212 and the second earbud device 222. The processing apparatus may include one or more processors having single or multiple processing cores. The processing apparatus may include memory, such as random access memory device (RAM), flash memory, or any other suitable type of storage device such as a non-transitory computer readable memory. The memory of the processing apparatus may include executable instructions and data that can be accessed by one or more processors of the processing apparatus. For example, the processing apparatus may include the processing apparatus 612 of FIG. 6A. For example, the processing apparatus may include the processing apparatus 662 of FIG. 6B. In some implementations, the processing apparatus also includes one more processors (e.g., of a laptop computer or a cloud server) in communication with a processor of the personal computing device 214 via wireless network communication protocols (e.g., Bluetooth or WiFi). In some implementations, the electrodes (e.g., the third electrode 234) are connected to the processing apparatus via one or more conductors connected in series (e.g., including a conductor of the cable 216).

The processing apparatus of the system 200 may be configured to access measurements of electrical potential of the first electrode, the second electrode, and the third electrode; determine a reference signal based on measurements of electrical potential of the first electrode; determine a ground signal (e.g., an active ground signal) based on measurements of electrical potential of the second electrode; and determine a first electroencephalography signal based on measurements of electrical potential of the third electrode and based on the reference signal. The processing apparatus of the system 200 may be configured to estimate a brain state (e.g., a focus score) based on the first electroencephalography signal.

In some implementations, where the system 200 includes one or more sensors for detecting motion of the earbuds with respect to their respective ear canals during use that can cause artifacts in the electroencephalography signals, the processing apparatus may be configured to access measurements from a contact microphone, and identify artifacts in the first electroencephalography signal caused by motion of the first eartip 210 within the ear canal based on the measurements from the contact microphone. For example, the processing apparatus may be configured to access measurements from an accelerometer, and identify artifacts in the first electroencephalography signal caused by motion of the first eartip 210 within the ear canal based on the measurements from the accelerometer. For example, the processing apparatus may be configured to access measurements from a gyroscope, and identify artifacts in the first electroencephalography signal caused by motion of the first eartip 210 within the ear canal based on the measurements from the gyroscope.

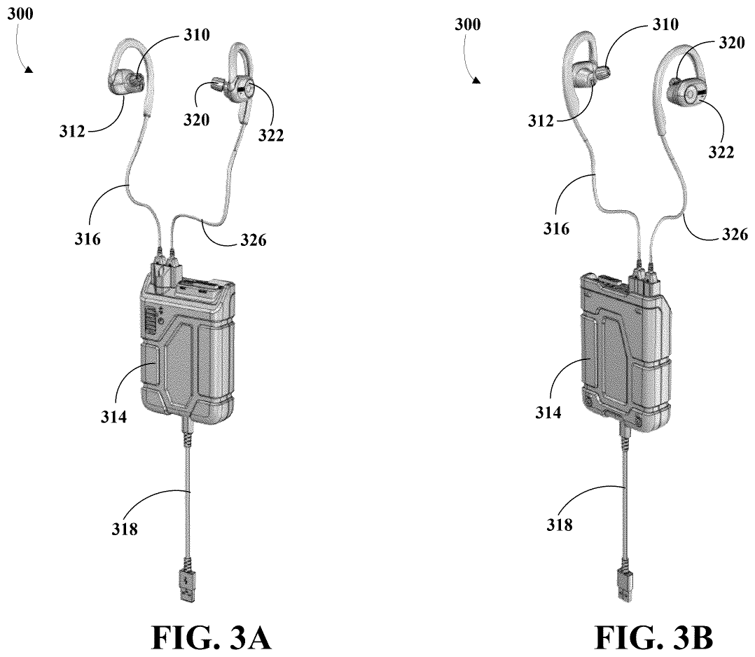

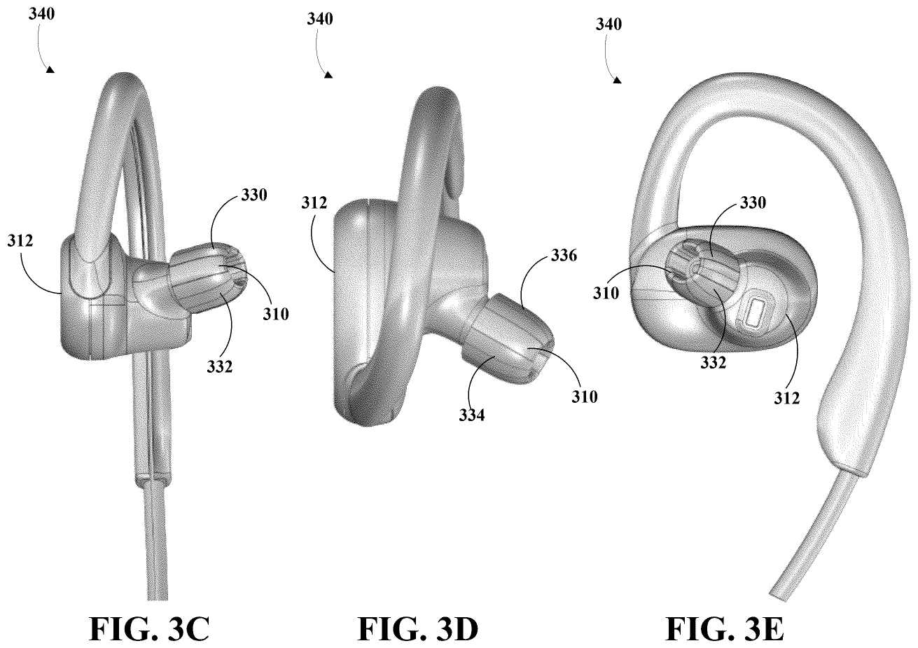

FIGS. 3A-E are illustrations of an example of a system 300 including an in-ear brain-computer interface with two eartips and two electroencephalography channels per ear. The system 300 includes a first eartip 310 shaped for insertion in an ear canal and a second eartip 320 shaped for insertion in an ear canal. The system 300 includes four electrodes (e.g., a first electrode, a second electrode, a third electrode and a fourth electrode) positioned on one or more outer surfaces of the first eartip 310. For example, the first eartip 310 may be the eartip 400 of FIG. 4A. The system 300 includes four electrodes (e.g., a fifth electrode, a sixth electrode, a seventh electrode, and a sixth electrode) positioned on one or more outer surfaces of the second eartip 320. For example, the second eartip 320 may be the eartip 400 of FIG. 4A. For example, these four electrodes on each eartip may respectively be used as common reference electrode, a ground/driven right leg (DRL) electrode, and two electroencephalography channel electrodes. Measurements of electrical potential of theses electrodes while the eartips 310 and 320 are inserted in their respective ear canals of a user may be used to determine a reference signal, a ground signal, and two electroencephalography signals from each ear. The electroencephalography signals may be determined as a voltage relative to their reference signals in the same ear canal. The electroencephalography signals may be used to estimate a brain state (e.g., by generating a focus score or some other metric of brain waves detected in the electroencephalography signals). For example, the system 300 may be used to implement the technique 700 of FIG. 7. For example, the system 300 may be used to implement the technique 800 of FIG. 8. For example, the system 300 may be used to implement the technique 900 of FIG. 9. For example, the system 300 may be used to implement the technique 1000 of FIG. 10. For example, the system 300 may be used to implement the technique 1100 of FIG. 11. For example, the system 300 may be used to implement the technique 1200 of FIG. 12.

The first eartip 310 is attached to a first earbud device 312 that includes a speaker (e.g., for playing music or other sounds for a user wearing the earbud device 312). The second eartip 320 is attached to a second earbud device 322 that includes a speaker. The system 300 also includes a personal computing device 314 that is connected to the first earbud device 312 via a cable 316. For example, the cable 316 may include conductors that may be used to transmit power from the personal computing device 314 to the first earbud device 312, and/or used to transmit data between the personal computing device 314 and the first earbud device 312 (e.g., using a serial port communications protocol, such as Universal Serial Bus (USB), Inter-Integrated Circuit (I²C) or Serial Peripheral Interface (SPI)). The system 300 also includes a cable 326 that connects the personal computing device 314 to the second earbud device 322. For example, the cable 326 may include conductors that may be used to transmit power from the personal computing device 314 to the second earbud device 322, and/or used to transmit data between the personal computing device 314 and the second earbud device 322. In this example, the personal computing device 314 is a controller module that includes a USB cable 318 to enable charging and/or communications with an additional computing device (e.g., a laptop). In some implementations, the first earbud device 312 and the second earbud device 322 include an array of microphones configured for use with the speakers to cancel noise.

FIGS. 3C-E are enlarged illustrations of components 340 of the system 300 from various perspectives, which include views of the four electrodes on an outer surface of the first eartip 310. For example, the main body of the first eartip 310 may be made of a flexible material that is an electrical insulator, such as, for example, silicone or rubber. The system 300 includes a first electrode 330 positioned on an outer surface of the first eartip 310, a second electrode 332 positioned on an outer surface of the first eartip 310, a third electrode 334 positioned on an outer surface of the first eartip 310, and a fourth electrode 336 positioned on an outer surface of the first eartip 310. In the example of FIGS. 3A-E, the four electrodes (330, 332, 334, and 336) are all positioned on a same outer surface of the first eartip 310, but in other examples, where an eartip includes multiple outer surfaces configured to come in contact with skin in an ear canal when the first eartip 310 is inserted in the ear canal, the four electrodes (330, 332, 334, and 336) may be positioned on different outer surfaces of the first eartip 310. The first electrode 330, the second electrode 332, the third electrode 334, and the fourth electrode 336 may each include an electrically conductive strip and may be coated with a conductive polymer (e.g., polyacetylene or polypyrrole). For example, the first electrode 330, the second electrode 332, the third electrode 334, and the fourth electrode 336 may each include metal foil and/or conductive fabric.

In this example, the first electrode 330, the second electrode 332, the third electrode 334, and the fourth electrode 336 extend laterally along the first eartip 310 from an anterior end of the first eartip 310 that will be inserted deepest into the ear canal to a posterior end of the first eartip 310. One or more of the electrodes (e.g., the third electrode 334) may be sized to fit entirely inside the ear canal. In this example, the first eartip 310 has a cylindrical outer surface and the first electrode 330, the second electrode 332, the third electrode 334, and the fourth electrode 336 are positioned around the cylindrical outer surface with strips of insulator (e.g., strips of the main body of the first eartip 310) on the cylindrical outer surface separating the first electrode 330, the second electrode 332, the third electrode 334, and the fourth electrode 336. In some implementations, an outer surface of the first eartip 310 has an oval cross section perpendicular to axis of insertion into the ear canal. The eccentricity of the cross section of the first eartip 310 may serve to fit more snugly in an ear canal and prevent or reduce rotation of the first eartip 310 within the ear canal during use.

The first eartip 310 and the second eartip 320 may be an easily replaceable components of the first earbud device 312 and the second earbud device 322 respectively. For example, system 300 may include multiple replaceable eartips of different sizes to better fit the ear canal of a particular user. In some implementations, the first eartip 310 is removably attached to the first earbud device 312 using a mechanical interface that includes a rotation locking mechanism configured to prevent rotation of the first eartip 310 about an axis of insertion into the ear canal. This rotation locking mechanism may serve to prevent or reduce movement of the electrodes (330, 332, 334, and 336) with respect to the electrical contacts on the earbud device 312 during use.

In some implementations, the system 300 includes circuitry configured to drive a driven right leg (DRL) voltage to the second electrode 332 to suppress common mode noise in the first electroencephalography signal. For example, circuitry configured to drive a DRL voltage on the second electrode 332 may be located in the first earbud device 312 and/or may include logic or processor or microcontroller components located in the personal computing device 314.

The system 300 may also include one or more sensors for detecting motion of the earbuds with respect to the ear canal they are in during use that can cause artifacts in the electroencephalography signals from the ear canals, which may enable the cancellation or suppression of these artifacts in the electroencephalography signals to improve signal to noise ratio (SNR) of the electroencephalography signals. For example, the system 300 may include a contact microphone positioned near an anterior end of the first eartip 310 (e.g., positioned in the first earbud device 312). For example, the system 300 may include an accelerometer positioned near an anterior end of the first eartip 310 (e.g., positioned in the first earbud device 312). For example, the system 300 may include a gyroscope (e.g., a microelectromechanical systems (MEMS) gyroscope) positioned near an anterior end of the first eartip 310 (e.g., positioned in the first earbud device 312).

In some implementations, the system uses only electrodes that are positioned inside an ear canal during use to detect electroencephalography signals used to estimate brain states and provide a brain-computer interface. For example, in some implementations, all electrodes on outer surfaces of the first earbud device 312 are positioned on the first eartip 310 to fit within an ear canal, and all electrodes on outer surfaces of the second earbud device 322 are positioned on the second eartip 320 to fit within a second ear canal.

The system 300 includes a processing apparatus, which may be distributed between the personal computing device 314 and/or the first earbud device 312 and the second earbud device 322. The processing apparatus may include one or more processors having single or multiple processing cores. The processing apparatus may include memory, such as random access memory device (RAM), flash memory, or any other suitable type of storage device such as a non-transitory computer readable memory. The memory of the processing apparatus may include executable instructions and data that can be accessed by one or more processors of the processing apparatus. For example, the processing apparatus may include the processing apparatus 612 of FIG. 6A. For example, the processing apparatus may include the processing apparatus 662 of FIG. 6B. In some implementations, the processing apparatus also includes one more processors (e.g., of a laptop computer or a cloud server) in communication with a processor of the personal computing device 314 via wireless network communication protocols (e.g., Bluetooth or WiFi). In some implementations, the electrodes (e.g., the third electrode 334) are connected to the processing apparatus via one or more conductors connected in series (e.g., including a conductor of the cable 316).

The processing apparatus of the system 300 may be configured to access measurements of electrical potential of the first electrode, the second electrode, and the third electrode; determine a reference signal based on measurements of electrical potential of the first electrode; determine a ground signal (e.g., an active ground signal) based on measurements of electrical potential of the second electrode; and determine a first electroencephalography signal based on measurements of electrical potential of the third electrode and based on the reference signal. The processing apparatus of the system 300 may be configured to estimate a brain state (e.g., a focus score) based on the first electroencephalography signal. For example, the processing apparatus may be configured to access measurements of electrical potential of the fourth electrode 336; determine a second electroencephalography signal based on measurements of electrical potential of the fourth electrode 336 and based on the reference signal; and estimate the brain state based on the second electroencephalography signal.

In some implementations, where the system 300 includes one or more sensors for detecting motion of the earbuds with respect to their respective ear canals during use that can cause artifacts in the electroencephalography signals, the processing apparatus may be configured to access measurements from a contact microphone, and identify artifacts in the first electroencephalography signal caused by motion of the first eartip 310 within the ear canal based on the measurements from the contact microphone. For example, the processing apparatus may be configured to access measurements from an accelerometer, and identify artifacts in the first electroencephalography signal caused by motion of the first eartip 310 within the ear canal based on the measurements from the accelerometer. For example, the processing apparatus may be configured to access measurements from a gyroscope, and identify artifacts in the first electroencephalography signal caused by motion of the first eartip 310 within the ear canal based on the measurements from the gyroscope.

FIGS. 4A-E are illustrations of an example of an eartip 400 with four electrodes. The eartip 400 may be shaped for insertion in an ear canal. The eartip 400 includes a first electrode 410 positioned on an outer surface of the eartip 400, a second electrode 412 positioned on an outer surface of the eartip 400, a third electrode 414 positioned on an outer surface of the eartip 400, and a fourth electrode 416 positioned on an outer surface of the eartip 400. These four electrodes are separated and electrically isolated from one another by strips of insulating material 420, 422, 424, and 426 (e.g., made of rubber or silicone).

The eartip 400 may be removably attached to an earbud device (e.g., the earbud device 112) using a mechanical interface 440 that includes a rotation locking mechanism configured to prevent rotation of the eartip 400 about an axis of insertion into the ear canal. This rotation locking mechanism (e.g., including one or notches or pegs) of the mechanical interface 440 may serve to prevent or reduce movement of the electrodes (410, 412, 414, and 416) with respect to electrical contacts on an earbud device 312 during use.

The first electrode 410, the second electrode 412, the third electrode 414 and the fourth electrode 416 extend laterally along the eartip from an anterior end of the eartip that will be inserted deepest into the ear canal to a posterior end of the eartip. In some implementations, the electrodes are sized such that their outer surfaces fit entirely inside the ear canal when the eartip 400 is inserted in the ear canal. In this example, the first electrode 410, the second electrode 412, the third electrode 414 and the fourth electrode 416 also extend laterally along an inner surface of the eartip to the mechanical interface 440 where the electrodes can make contact with corresponding electrical contact pads on an earbud device when the eartip 400 is attached to the earbud device. For example, the eartip 400 may have a cylindrical outer surface and the first electrode 410, the second electrode 412, and the third electrode 414, and the fourth electrode 416 may be positioned around the cylindrical outer surface with strips of insulator 420, 422, 424, and 426 on the cylindrical outer surface separating the first electrode 410, the second electrode 412, and the third electrode 414, and the fourth electrode 416. In some implementations, an outer surface of the eartip 400 has an oval cross section perpendicular to axis of insertion into the ear canal. The eccentricity of the cross section of the eartip 400 may serve to fit more snugly in an ear canal and prevent or reduce rotation of the eartip 400 within the ear canal during use.

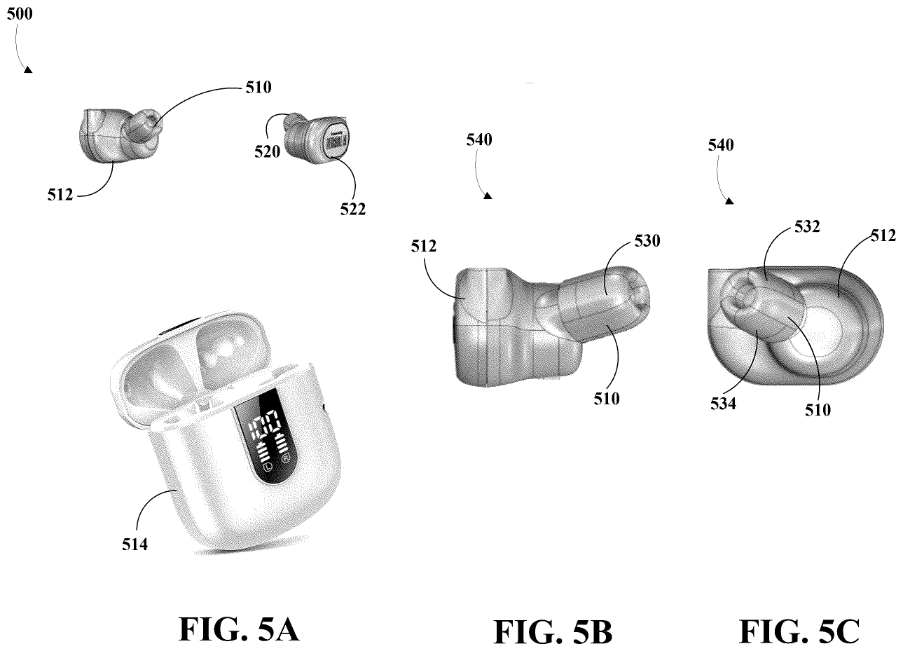

FIGS. 5A-C are illustrations of an example of a system 500 including in-ear brain-computer interface with wireless earbud devices in communication with a smart charging case. The system 500 includes a first eartip 510 shaped for insertion in an ear canal and a second eartip 520 shaped for insertion in an ear canal. The system 500 includes three electrodes (e.g., a first electrode, a second electrode, and a third electrode) positioned on one or more outer surfaces of the first eartip 510. For example, the first eartip 510 may be similar in structure to the eartip 400 of FIG. 4A. The system 500 includes three electrodes (e.g., a fourth electrode, a fifth electrode, and a sixth electrode) positioned on one or more outer surfaces of the second eartip 520. For example, the second eartip 520 may be similar in structure to the eartip 400 of FIG. 4A. For example, these three electrodes on each eartip may respectively be used as common reference electrode, a ground/driven right leg (DRL) electrode, and an electroencephalography channel electrode. Measurements of electrical potential of theses electrodes while the eartips 510 and 520 are inserted in their respective ear canals of a user may be used to determine a reference signal, a ground signal, and an electroencephalography signal from each ear. The electroencephalography signals may be determined as a voltage relative to their reference signals in the same ear canal. The electroencephalography signals may be used to estimate a brain state (e.g., by generating a focus score or some other metric of brain waves detected in the electroencephalography signals). For example, the system 500 may be used to implement the technique 700 of FIG. 7. For example, the system 500 may be used to implement the technique 800 of FIG. 8. For example, the system 500 may be used to implement the technique 900 of FIG. 9. For example, the system 500 may be used to implement the technique 1000 of FIG. 10. For example, the system 500 may be used to implement the technique 1100 of FIG. 11. For example, the system 500 may be used to implement the technique 1200 of FIG. 12.

The first eartip 510 is attached to a first earbud device 512 that includes a speaker (e.g., for playing music or other sounds for a user wearing the earbud device 512). The second eartip 520 is attached to a second earbud device 522 that includes a speaker. The system 500 also includes a personal computing device 514 that is configured to communicate with the earbud device 512 via a wireless communications link (e.g., a Bluetooth link). For example, measurements of electrical potential of the first electrode 530, the second electrode 532, and the third electrode 534 that are in contact with an inside surface of an ear canal may be amplified and converted to digital samples in the earbud device 512 before being transmitted to a processor in the personal computing device 514 via the wireless communications link. In this example, the personal computing device 514 is a smart charging case that includes battery and a compartment that is fitted to the first earbud device 512 and the second earbud device 522 and can be used to charge batteries in the first earbud device 512 and the second earbud device 522 when they are not in use. In some implementations, the first earbud device 512 and the second earbud device 522 include an array of microphones configured for use with the speakers to cancel noise.

FIGS. 5B-C are enlarged illustrations of components 540 of the system 500 from various perspectives, which include views of the three electrodes on an outer surface of the first eartip 510. For example, the main body of the first eartip 510 may be made of a flexible material that is an electrical insulator, such as, for example, silicone or rubber. The system 500 includes a first electrode 530 positioned on an outer surface of the first eartip 510, a second electrode 532 positioned on an outer surface of the first eartip 510, a third electrode 534 positioned on an outer surface of the first eartip 510. In the example of FIGS. 5A-E, the three electrodes (530, 532, and 534) are all positioned on a same outer surface of the first eartip 510, but in other examples, where an eartip includes multiple outer surfaces configured to come in contact with skin in an ear canal when the first eartip 510 is inserted in the ear canal, the three electrodes (530, 532, and 534) may be positioned on different outer surfaces of the first eartip 510. The first electrode 530, the second electrode 532, and the third electrode 534 may each include an electrically conductive strip and may be coated with a conductive polymer (e.g., polyacetylene or polypyrrole). For example, the first electrode 530, the second electrode 532, and the third electrode 534 may each include metal foil and/or conductive fabric.

In this example, the first electrode 530, the second electrode 532, and the third electrode 534 extend laterally along the first eartip 510 from an anterior end of the first eartip 510 that will be inserted deepest into the ear canal to a posterior end of the first eartip 510. One or more of the electrodes (e.g., the third electrode 534) may be sized to fit entirely inside the ear canal. In this example, the first eartip 510 has a cylindrical outer surface and the first electrode 530, the second electrode 532, and the third electrode 534 are positioned around the cylindrical outer surface with strips of insulator (e.g., strips of the main body of the first eartip 510) on the cylindrical outer surface separating the first electrode 530, the second electrode 532, and the third electrode 534. In some implementations, an outer surface of the first eartip 510 has an oval cross section perpendicular to axis of insertion into the ear canal. The eccentricity of the cross section of the first eartip 510 may serve to fit more snugly in an ear canal and prevent or reduce rotation of the first eartip 510 within the ear canal during use.

The first eartip 510 and the second eartip 520 may be an easily replaceable components of the first earbud device 512 and the second earbud device 522 respectively. For example, system 500 may include multiple replaceable eartips of different sizes to better fit the ear canal of a particular user. In some implementations, the first eartip 510 is removably attached to the first earbud device 512 using a mechanical interface that includes a rotation locking mechanism configured to prevent rotation of the first eartip 510 about an axis of insertion into the ear canal. This rotation locking mechanism may serve to prevent or reduce movement of the electrodes (530, 532, and 534) with respect to the electrical contacts on the earbud device 312 during use.

In some implementations, the system 500 includes circuitry configured to drive a driven right leg (DRL) voltage to the second electrode 532 to suppress common mode noise in the first electroencephalography signal. For example, circuitry configured to drive a DRL voltage on the second electrode 532 may be located in the first earbud device 512 and/or may include logic or processor or microcontroller components located in the personal computing device 514.

The system 500 may also include one or more sensors for detecting motion of the earbuds with respect to the ear canal they are in during use that can cause artifacts in the electroencephalography signals from the ear canals, which may enable the cancellation or suppression of these artifacts in the electroencephalography signals to improve signal to noise ratio (SNR) of the electroencephalography signals. For example, the system 500 may include a contact microphone positioned near an anterior end of the first eartip 510 (e.g., positioned in the first earbud device 512). For example, the system 500 may include an accelerometer positioned near an anterior end of the first eartip 510 (e.g., positioned in the first earbud device 512). For example, the system 500 may include a gyroscope (e.g., a microelectromechanical systems (MEMS) gyroscope) positioned near an anterior end of the first eartip 510 (e.g., positioned in the first earbud device 512).

In some implementations, the system uses only electrodes that are positioned inside an ear canal during use to detect electroencephalography signals used to estimate brain states and provide a brain-computer interface. For example, in some implementations, all electrodes on outer surfaces of the first earbud device 512 are positioned on the first eartip 510 to fit within an ear canal, and all electrodes on outer surfaces of the second earbud device 522 are positioned on the second eartip 520 to fit within a second ear canal.

The system 500 includes a processing apparatus, which may be distributed between the personal computing device 514 and/or the first earbud device 512 and the second earbud device 522. The processing apparatus may include one or more processors having single or multiple processing cores. The processing apparatus may include memory, such as random access memory device (RAM), flash memory, or any other suitable type of storage device such as a non-transitory computer readable memory. The memory of the processing apparatus may include executable instructions and data that can be accessed by one or more processors of the processing apparatus. For example, the processing apparatus may include the processing apparatus 612 of FIG. 6A. For example, the processing apparatus may include the processing apparatus 662 of FIG. 6B. In some implementations, the processing apparatus also includes one more processors (e.g., of a laptop computer or a cloud server) in communication with a processor of the personal computing device 514 via wireless network communication protocols (e.g., Bluetooth or WiFi). In some implementations, the processing apparatus receives the measurements of electrical potential of the third electrode via a wireless communications link (e.g., a Bluetooth link).

The processing apparatus of the system 500 may be configured to access measurements of electrical potential of the first electrode, the second electrode, and the third electrode; determine a reference signal based on measurements of electrical potential of the first electrode; determine a ground signal (e.g., an active ground signal) based on measurements of electrical potential of the second electrode; and determine a first electroencephalography signal based on measurements of electrical potential of the third electrode and based on the reference signal. The processing apparatus of the system 500 may be configured to estimate a brain state (e.g., a focus score) based on the first electroencephalography signal.

In some implementations, where the system 500 includes one or more sensors for detecting motion of the earbuds with respect to their respective ear canals during use that can cause artifacts in the electroencephalography signals, the processing apparatus may be configured to access measurements from a contact microphone, and identify artifacts in the first electroencephalography signal caused by motion of the first eartip 510 within the ear canal based on the measurements from the contact microphone. For example, the processing apparatus may be configured to access measurements from an accelerometer, and identify artifacts in the first electroencephalography signal caused by motion of the first eartip 510 within the ear canal based on the measurements from the accelerometer. For example, the processing apparatus may be configured to access measurements from a gyroscope, and identify artifacts in the first electroencephalography signal caused by motion of the first eartip 510 within the ear canal based on the measurements from the gyroscope.

FIG. 6A is a block diagram of an example of a system 600 including an in-ear brain-computer interface. The system 600 includes a headset 610 including one or two earbud devices and/or a personal computing device. The headset 610 includes a processing apparatus 612, an eartip 614 with electrodes, one or more motion sensors 616, a communications interface 618, a user interface 620, and a battery 622. The components of the headset 610 may communicate with each other via a bus 624. The system 600 may be used to implement processes described in this disclosure, such as the technique 700 of FIG. 7, the technique 800 of FIG. 8, the technique 900 of FIG. 9, the technique 1000 of FIG. 10, the technique 1100 of FIG. 11, and/or the technique 1200 of FIG. 12.

The headset 610 includes an eartip 614 (e.g., the eartip 110 or the eartip 400) with electrodes. The system 600 includes a first electrode positioned on an outer surface of the eartip 614, a second electrode positioned on an outer surface of the eartip 614, and a third electrode positioned on an outer surface of the eartip 614. In some implementations, the system 600 includes additional electrodes on the eartip 614. For example, the system 600 may include a fourth electrode (e.g., the fourth electrode 416) positioned on an outer surface of the eartip 614. The eartip 614 may be removably attached to an earbud device of the headset 610 and the eartip 614 may be shaped for insertion in an ear canal. The eartip 614 may be configured to position the first electrode, the second electrode and the third electrode in contact with an inside surface (i.e., skin) of an ear canal.

The headset 610 includes a processing apparatus 612. The processing apparatus 612 may include one or more processors having single or multiple processing cores. The processing apparatus 612 may include memory, such as random access memory device (RAM), flash memory, or any other suitable type of storage device such as a non-transitory computer readable memory. The memory of the processing apparatus 612 may include executable instructions and data that can be accessed by one or more processors of the processing apparatus 612. For example, the processing apparatus 612 may include one or more DRAM modules such as double data rate synchronous dynamic random-access memory (DDR SDRAM). In some implementations, the processing apparatus 612 may include a digital signal processor (DSP). In some implementations, the processing apparatus 612 may include an application specific integrated circuit (ASIC). For example, the processing apparatus 612 may include a custom vector processor for efficiently executing machine learning models at an inference phase. The processing apparatus 612 may be spatially distributed between components of the headset 610, such as personal computing device (e.g., the personal computing device 114, the personal computing device 214, or the personal computing device 314), a first earbud device (e.g., the first earbud device 112, the first earbud device 212, or the first earbud device 312), and/or a second earbud device (e.g., the second earbud device 222 or the second earbud device 322). For example, different components of the processing apparatus 612 may communicate with each other via one more serial port links (e.g., via conductors of the cable 116, the cable 216, the cable 316, or the cable 316) or via another communications protocol/network topology.

The processing apparatus 612 may be configured to access measurements of electrical potential of the first electrode, the second electrode, and the third electrode; determine a reference signal based on measurements of electrical potential of the first electrode; determine a ground signal based on measurements of electrical potential of the second electrode; determine a first electroencephalography signal based on measurements of electrical potential of the third electrode and based on the reference signal; and estimate a brain state based on the first electroencephalography signal. In some implementations, the eartip 614 includes a fourth electrode and the processing apparatus 612 is configured to access measurements of electrical potential of the fourth electrode; determine a second electroencephalography signal based on measurements of electrical potential of the fourth electrode and based on the reference signal; and estimate the brain state based on the second electroencephalography signal.

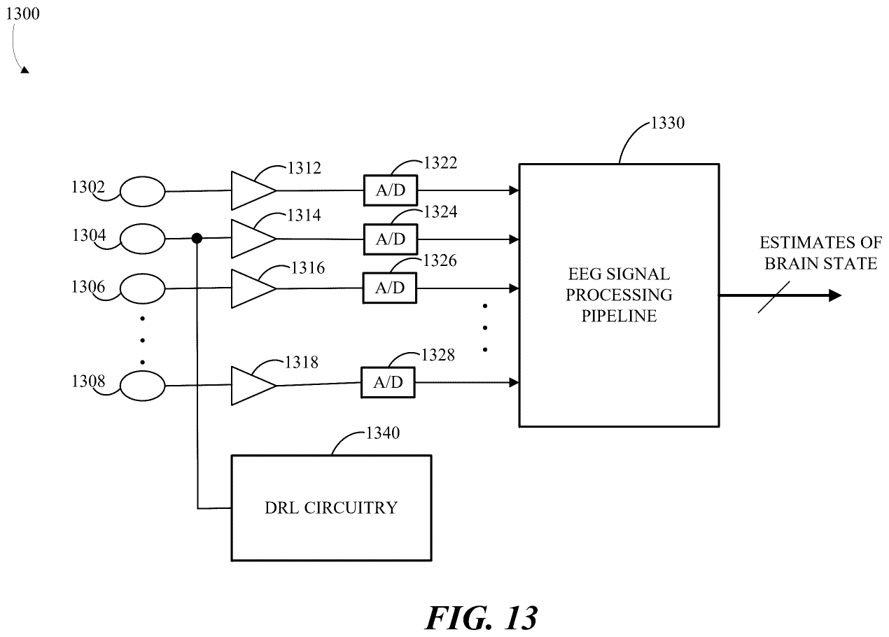

Although not explicitly shown in FIG. 6A, the headset 610 may include measurement circuitry configured to measure voltages at the electrodes on the eartip 614 and make those measurements accessible (e.g., directly or via the bus 624) to the processing apparatus 612. For example, the headset 610 may include circuitry depicted in the signal flow 1300 of FIG. 13 for amplifying and sampling the voltages at the electrodes on the eartip 614.

The headset 610 includes one or more motion sensors 616, which may be configured to detect motion of an earbud of the headset 610 with respect to an ear canal during use that can cause artifacts in an electroencephalography signal. For example, the one or more motion sensors 616 may include a contact sensor positioned near an anterior end of the eartip 614, an accelerometer, and/or a gyroscope. For example, the processing apparatus 612 may be configured to access measurements from a contact microphone, and identify artifacts in the first electroencephalography signal caused by motion of the eartip 614 within the ear canal based on the measurements from the contact microphone. For example, the processing apparatus may be configured to access measurements from an accelerometer, and identify artifacts in the first electroencephalography signal caused by motion of the eartip 614 within the ear canal based on the measurements from the accelerometer. For example, the processing apparatus may be configured to access measurements from a gyroscope, and identify artifacts in the first electroencephalography signal caused by motion of the eartip 614 within the ear canal based on the measurements from the gyroscope.

The headset 610 may include the communications interface 618, which may enable communications with a personal computing device (e.g., a smartphone, a tablet, or a laptop computer). For example, the communications interface 618 may be used to receive commands controlling operation of the and configuration of an in-ear brain-computer interface provided by the headset 610. For example, the communications interface 618 may be used to transfer data (e.g., including an indication of an estimated brain state and/or electroencephalography signals) from the brain-computer interface to a personal computing device. For example, the communications interface 618 may include a wired interface, such as a universal serial bus (USB) interface or a FireWire interface. For example, the communications interface 618 may include a wireless interface, such as a Bluetooth interface, a ZigBee interface, and/or a Wi-Fi interface.

The headset 610 may include a user interface 620. For example, the user interface 620 may include a speaker in an earbud device of the headset 610, which may be used to play audio signals, including audio prompts for a user. For example, the user interface 620 may include one or more microphones, which may configured accept audio signals and detect verbal commands from a user. For example, the user interface 620 may include an LCD display for presenting images and/or messages to a user. For example, the user interface 620 may include a button or switch enabling a person to manually turn the headset 610 on and off. For example, the user interface 620 may include a button or capacitive touch sensor for activating or deactivating the in-ear brain-computer interface.

The headset 610 may include the battery 622 that powers the headset 610 and/or its peripherals. For example, the battery 622 may be charged wirelessly or through a micro-USB interface.

FIG. 6B is a block diagram of an example of a system 630 including an in-ear brain-computer interface. The system 630 includes an earbud device 640 (e.g., the earbud device 512) including and a personal computing device 660 (e.g., the personal computing device 514, a smartphone, or a tablet) that communicates with the earbud device 640 via a wireless communications link 650. The earbud device 640 includes an eartip 642 with electrodes, one or more motion sensors 644, and a communications interface 646, which may communicate with each other via a bus 648. The personal computing device 660 includes a processing apparatus 662, a user interface 664, and a communications interface 666, which may communicate with each other via a bus 668. In some implementations (not shown in FIG. 6B), the system 630 includes a second earbud device (e.g., the second earbud device 522) for a second ear canal, which is similar to the first earbud device 640 and is also in communication with the personal computing device 660 via a wireless communications link. The system 630 may be used to implement processes described in this disclosure, such as the technique 700 of FIG. 7, the technique 800 of FIG. 8, the technique 900 of FIG. 9, the technique 1000 of FIG. 10, the technique 1100 of FIG. 11, and/or the technique 1200 of FIG. 12.

The earbud device 640 includes an eartip 642 (e.g., the eartip 510 or the eartip 400) with electrodes. The system 630 includes a first electrode positioned on an outer surface of the eartip 642, a second electrode positioned on an outer surface of the eartip 642, and a third electrode positioned on an outer surface of the eartip 642. In some implementations, the system 630 includes additional electrodes on the eartip 642. For example, the system 630 may include a fourth electrode (e.g., the fourth electrode 416) positioned on an outer surface of the eartip 642. The eartip 642 may be removably attached to the earbud device 640 and the eartip 642 may be shaped for insertion in an ear canal. The eartip 642 may be configured to position the first electrode, the second electrode and the third electrode in contact with an inside surface (i.e., skin) of an ear canal.

The personal computing device 660 includes a processing apparatus 662. The processing apparatus 662 may include one or more processors having a single or multiple processing cores. The processing apparatus 662 may include memory, such as random access memory device (RAM), flash memory, or any other suitable type of storage device such as a non-transitory computer readable memory. The memory of the processing apparatus 662 may include executable instructions and data that can be accessed by one or more processors of the processing apparatus 662. For example, the processing apparatus 662 may include one or more DRAM modules such as double data rate synchronous dynamic random-access memory (DDR SDRAM). In some implementations, the processing apparatus 662 may include a digital signal processor (DSP). In some implementations, the processing apparatus 662 may include an application specific integrated circuit (ASIC). For example, the processing apparatus 662 may include a custom vector processor for efficiently executing machine learning models at an inference phase.

The processing apparatus 662 may be configured to access measurements of electrical potential of the first electrode, the second electrode, and the third electrode; determine a reference signal based on measurements of electrical potential of the first electrode; determine a ground signal (e.g., an active ground signal) based on measurements of electrical potential of the second electrode; determine a first electroencephalography signal based on measurements of electrical potential of the third electrode and based on the reference signal; and estimate a brain state based on the first electroencephalography signal. In some implementations, the eartip 642 includes a fourth electrode and the processing apparatus 662 is configured to access measurements of electrical potential of the fourth electrode; determine a second electroencephalography signal based on measurements of electrical potential of the fourth electrode and based on the reference signal; and estimate the brain state based on the second electroencephalography signal. The processing apparatus 662 may be configured to receive the measurements of electrical potential of the third electrode via the wireless communications link 650, using the communications interface 666.

Although not explicitly shown in FIG. 6B, the earbud device 640 may include measurement circuitry configured to measure voltages at the electrodes on the eartip 642 and make those measurements accessible (e.g., via the bus 648 and the communication interface 646) to the processing apparatus 662. For example, the earbud device 640 may include circuitry depicted in the signal flow 1300 of FIG. 13 for amplifying and sampling the voltages at the electrodes on the eartip 642.

The earbud device 640 includes one or more motion sensors 644, which may be configured to detect motion of an earbud device 640 with respect to an ear canal during use that can cause artifacts in an electroencephalography signal. For example, the one or more motion sensors 644 may include a contact sensor positioned near an anterior end of the eartip 642, an accelerometer, and/or a gyroscope. For example, the processing apparatus 662 may be configured to access measurements from a contact microphone, and identify artifacts in the first electroencephalography signal caused by motion of the eartip 642 within the ear canal based on the measurements from the contact microphone. For example, the processing apparatus may be configured to access measurements from an accelerometer, and identify artifacts in the first electroencephalography signal caused by motion of the eartip 642 within the ear canal based on the measurements from the accelerometer. For example, the processing apparatus may be configured to access measurements from a gyroscope, and identify artifacts in the first electroencephalography signal caused by motion of the eartip 642 within the ear canal based on the measurements from the gyroscope.

The earbud device 640 includes the communications interface 646 and the personal computing device 660 includes the communications interface 666, which may together enable communications between the two devices via the wireless communications link 650. For example, the communications interface 646 may be used to receive commands controlling operation of the and configuration of an in-ear brain-computer interface provided by the earbud device 640. For example, the wireless communications link 650 may be used to transfer data (e.g., including measurements of electrical potential of the first electrode, the second electrode, and the third electrode) from the earbud device 640 to the personal computing device 660. For example, the communications interface 646 and the communication interface 666 may include a wireless interface, such as a Bluetooth interface, a ZigBee interface, and/or a Wi-Fi interface.

The personal computing device 660 may include a user interface 664. For example, the user interface 664 may include a controller for a speaker in the earbud device 640, which may be used to play audio signals, including audio prompts for a user. For example, the user interface 664 may include one or more microphones, which may configured accept audio signals and detect verbal commands from a user. For example, the user interface 664 may include an LCD display for presenting images and/or messages to a user. For example, the user interface 664 may include a button or capacitive touch sensor for activating or deactivating the in-ear brain-computer interface.

FIG. 7 is flowchart of an example of a technique 700 for providing an in-ear brain-computer interface. The technique 700 includes accessing 702 measurements of electrical potential of a first electrode, a second electrode, and a third electrode that are in contact with an inside surface of an ear canal; determining 704 a reference signal based on measurements of electrical potential of the first electrode; determining 706 a ground signal based on measurements of electrical potential of the second electrode; determining 708 a first electroencephalography signal based on measurements of electrical potential of the third electrode and based on the reference signal; estimating 710 a brain state based on the first electroencephalography signal; and storing, displaying, or transmitting 712 an indication of the estimated brain state. For example, technique 700 may be implemented using the system 100 of FIGS. 1A-E. For example, technique 700 may be implemented using the system 200 of FIGS. 2A-E. For example, technique 700 may be implemented using the system 300 of FIGS. 3A-E. For example, technique 700 may be implemented using the system 500 of FIGS. 5A-C. For example, technique 700 may be implemented using the system 600 of FIG. 6A. For example, technique 700 may be implemented using the system 630 of FIG. 6B.

The technique 700 includes accessing 702 measurements of electrical potential of a first electrode, a second electrode, and a third electrode that are in contact with an inside surface of an ear canal. In some implementations, accessing 702 the measurements of electrical potential includes sampling (e.g., at 300 Hz) the electrical potential of a conductor connected to the third electrode. For example, the measurements of electrical potential may be accessed 702 using the signal flow 1300 of FIG. 13. In some implementations, accessing 702 the measurements of electrical potential includes receiving the measurements of electrical potential of the electrodes (e.g., including the third electrode 534) via a wireless communications link (e.g. the wireless communications link 650). For example, the measurements of electrical potential may be received using the communications interface 666 of the personal computing device 660.

The technique 700 includes determining 704 a reference signal based on measurements of electrical potential of the first electrode. For example, the reference signal may be a digital signal including a sequence of samples (e.g., sampled at 300 Hz) of voltage at the first electrode. In some implementations, the voltage at the first electrode may be amplified before it is sampled and converted to a digital signal that can be forwarded to one or more processors of a processing apparatus (e.g., the processing apparatus 612 or the processing apparatus 662) for analysis.

The technique 700 includes determining 706 a ground signal based on measurements of electrical potential of the second electrode. For example, the ground signal may be an active ground signal. For example, the ground signal may be a digital signal including a sequence of samples (e.g., sampled at 300 Hz) of voltage at the second electrode. In some implementations, the voltage at the second electrode may be amplified before it is sampled and converted to a digital signal that can be forwarded to one or more processors of a processing apparatus (e.g., the processing apparatus 612 or the processing apparatus 662) for analysis. The second electrode may be used to apply driven right leg (DRL) signal to the ear canal to suppress common mode noise that may be present at the electrodes. For example, the technique 800 of FIG. 8 may be implemented to suppress common mode noise at the electrodes.

The technique 700 includes determining 708 a first electroencephalography signal based on measurements of electrical potential of the third electrode and based on the reference signal. The first electroencephalography signal may include signals from a brain of a user. For example, the first electroencephalography signal may be a digital signal including a sequence of samples (e.g., sampled at 300 Hz) of voltage between the third electrode and the first electrode. In some implementations, the voltage at the third electrode may be amplified before it is sampled and converted to a digital signal that can be forwarded to one or more processors of a processing apparatus (e.g., the processing apparatus 612 or the processing apparatus 662) for analysis. For example, determining 708 a first electroencephalography signal may include subtracting samples of voltage at the third electrode from corresponding samples of voltage at the first electrode. In some implementations, additional channels of electroencephalography data may be acquired using additional electrodes to improve detection of electromagnetic signals from the brain. For example, the technique 900 of FIG. 9 may be implemented to utilize a fourth electrode in contact with the ear canal to determine a second electroencephalography signal. In some implementations, additional channels of electroencephalography data may be acquired using electrodes that are in contact with an inside surface of a second ear canal of the user (e.g., electrodes of the second eartip 520). In some implementations, determining 708 the first electroencephalography signal may include filtering to remove noise (e.g., 50 Hz or 60 Hz noise from power lines).

The technique 700 includes estimating 710 a brain state based on the first electroencephalography signal. For example, the brain state may include an amplitude or power of alpha waves (e.g., in a frequency range of 8 Hz to 12 Hz) present in an analysis window (e.g., a 1 second or 2 second analysis window). For example, the brain state may include an amplitude or power of beta waves (e.g., in a frequency range of 12 Hz to 30 Hz), gamma waves (e.g., in a frequency range of 30 Hz to 100 Hz), theta waves (e.g., in a frequency range of 4 Hz to 8 Hz), and/or delta waves (e.g., in a frequency range of 1 Hz to 4 Hz) present in an analysis window. For example, estimating 710 the brain state may include performing a power spectral density analysis (e.g., using a Fast Fourier Transform (FFT)) of the first electroencephalography signal in a window of time. In some implementations, the estimate of brain state includes a prediction generated with a machine learning model based on a window of samples from the first electroencephalography signal and/or features derived from the first electroencephalography signal. The prediction is an inference phase output of the machine learning model (e.g., including a neural network with one or more hidden layers), which, as a result of training of the model, may be correlated with a brain activity or status of the brain. For example, the estimate of brain state may include a prediction correlated with a level of focus, a level of attentiveness, a level of cognitive load, fatigue, or sleepiness. In some implementations, the estimated brain state includes a vector of predictions and/or features determined based on the first electroencephalography signal and/or additional electroencephalography signals captured from a user.

The technique 700 includes storing, displaying, or transmitting 712 an indication of the estimated brain state. For example, the indication of the estimated brain state may be transmitted 712 to an external device (e.g., a smartphone, laptop, or tablet) for display or storage. For example, the indication of the estimated brain state may be transmitted 712 via the communications interface 618. For example, the indication of the estimated brain state may be displayed 712 in the user interface 620 or in the user interface 664. For example, the indication of the estimated brain state may be stored 712 in memory of the processing apparatus 612 or in memory of the processing apparatus 662.

FIG. 8 is flowchart of an example of a technique 800 for suppressing common mode noise in one or more electroencephalography channels of an in-ear brain-computer interface. The technique 800 includes driving 802 a driven right leg (DRL) voltage to the second electrode to suppress common mode noise in the first electroencephalography signal. For example, the DRL voltage may be generated using circuitry including an inverting amplifier configured to detect the common voltage between the first electrode and the third electrode, invert the common voltage, and the add it back to the ear canal via the second electrode to suppress common mode noise in the measurements used to determine one or more electroencephalography signals. For example, technique 800 may be implemented using the system 100 of FIGS. 1A-E. For example, technique 800 may be implemented using the system 200 of FIGS. 2A-E. For example, technique 800 may be implemented using the system 300 of FIGS. 3A-E. For example, technique 800 may be implemented using the system 500 of FIGS. 5A-C. For example, technique 800 may be implemented using the system 600 of FIG. 6A. For example, technique 800 may be implemented using the system 630 of FIG. 6B.

FIG. 9 is flowchart of an example of a technique 900 for adding an additional electroencephalography channel in an in-ear brain-computer interface. The technique 900 includes accessing 902 measurements of electrical potential of a fourth electrode that is in contact with the inside surface of the ear canal; determining 904 a second electroencephalography signal based on measurements of electrical potential of the fourth electrode and based on the reference signal; and estimating 906 the brain state based on the second electroencephalography signal. For example, technique 900 may be implemented using the system 100 of FIGS. 1A-E. For example, technique 900 may be implemented using the system 200 of FIGS. 2A-E. For example, technique 900 may be implemented using the system 300 of FIGS. 3A-E. For example, technique 900 may be implemented using the system 500 of FIGS. 5A-C. For example, technique 900 may be implemented using the system 600 of FIG. 6A. For example, technique 900 may be implemented using the system 630 of FIG. 6B.

The technique 900 includes accessing 902 measurements of electrical potential of a fourth electrode that is in contact with the inside surface of the ear canal. In some implementations, accessing 902 the measurements of electrical potential of the fourth electrode includes sampling (e.g., at 300 Hz) the electrical potential of a conductor connected to the fourth electrode. For example, the measurements of electrical potential may be accessed 902 using the signal flow 1300 of FIG. 13. In some implementations, accessing 902 the measurements of electrical potential includes receiving the measurements of electrical potential of the fourth electrode via a wireless communications link (e.g. the wireless communications link 650). For example, the measurements of electrical potential of the fourth electrode may be received using the communications interface 666 of the personal computing device 660.

The technique 900 includes determining 904 a second electroencephalography signal based on measurements of electrical potential of the fourth electrode and based on the reference signal. The second electroencephalography signal may include signals from a brain of a user. The second electroencephalography signal may provide an additional channel of data regarding brain signals when combined with the first electroencephalography signal and/or other electroencephalography signals. For example, the second electroencephalography signal may be a digital signal including a sequence of samples (e.g., sampled at 300 Hz) of voltage between the fourth electrode and the first electrode. In some implementations, the voltage at the fourth electrode may be amplified before it is sampled and converted to a digital signal that can be forwarded to one or more processors of a processing apparatus (e.g., the processing apparatus 612 or the processing apparatus 662) for analysis. For example, determining 904 the second electroencephalography signal may include subtracting samples of voltage at the fourth electrode from corresponding samples of voltage at the first electrode. In some implementations, determining 904 the second electroencephalography signal may include filtering to remove noise (e.g., 50 Hz or 60 Hz noise from power lines).

The technique 900 includes estimating 906 the brain state based on the second electroencephalography signal. For example, estimating 906 the brain state may include analyzing the second electroencephalography signal the in the same ways described above for analyzing the first electroencephalography signal to estimate 710 the brain state. In some implementations, additional analysis may be performed to compare the first electroencephalography signal and the second electroencephalography signal. For example, coherence features may be determined that represent how respective signals from different electrodes correspond to each other. Coherence features may be based on comparisons of powerband data from respective pairs of electrodes (e.g., the third electrode 414 and the fourth electrode 416). The comparisons may determine a degree of similarity between the corresponding electrodes with respect to each compared power band (e.g. alpha, beta, theta, delta, and/or gamma). In some embodiments higher levels of coherence may between corresponding electrodes may indicate a higher signal to noise ratio. The coherence features may be input, along with other features based on the first electroencephalography signal and the second electroencephalography signal to one or more machine learning models that are used to generate one or more predictions as components of the estimated brain state. For example, the estimated brain state may include predictions that are correlated with a level of focus, a level of attentiveness, a level of cognitive load, fatigue, and/or sleepiness.

FIG. 10 is flowchart of an example of a technique 1000 for identifying artifacts in an electroencephalography signal caused by motion of an eartip using a contact microphone. The technique 1000 includes accessing 1002 measurements from a contact microphone; and identifying 1004 artifacts in the first electroencephalography signal caused by motion of the third electrode within the ear canal based on the measurements from the contact microphone. For example, technique 1000 may be implemented using the system 100 of FIGS. 1A-E. For example, technique 1000 may be implemented using the system 200 of FIGS. 2A-E. For example, technique 1000 may be implemented using the system 300 of FIGS. 3A-E. For example, technique 1000 may be implemented using the system 500 of FIGS. 5A-C. For example, technique 1000 may be implemented using the system 600 of FIG. 6A. For example, technique 1000 may be implemented using the system 630 of FIG. 6B.

The technique 1000 includes accessing 1002 measurements from a contact microphone. The contact microphone may be part of an earbud device (e.g., the earbud device 112, the earbud device 212, the earbud device 312, the earbud device 512 or the earbud device 640). For example, the contact microphone may be positioned near an anterior end of an eartip on the earbud device. For example, the measurements may be accessed 1002 by reading the measurements from the contact microphone via a bus (e.g., the bus 624). In some implementations, accessing 1002 measurements may include receiving the measurements via a communications link (e.g., the wireless communications link 650). For example, the measurements may be accessed 1002 via a wireless or wired communications interface (e.g., Wi-Fi, Bluetooth, USB, HDMI, Wireless USB, Near Field Communication (NFC), Ethernet, a radio frequency transceiver, and/or other interfaces). For example, the measurements may be accessed 1002 using communications interface 666.

The technique 1000 includes identifying 1004 artifacts in the first electroencephalography signal caused by motion of the third electrode within the ear canal based on the measurements from the contact microphone. The contact microphone may record loud sounds when an eartip on which the electrodes are positioned in is moved within the canal. This type of motion may cause transient changes in impedance between the electrodes and the skin of the ear canal. The measurements from the contact microphone may be analyzed to detect such a motion related event and to predict how an artifact of this event would manifest in the first electroencephalography signal. For example, identifying 1004 artifacts in the first electroencephalography signal may include passing a sequence of measurements from the contact microphone through a high-pass filter and comparing the output of the filter to threshold. Identifying 1004 such an artifact in the first electroencephalography signal may enable the artifact to be subtracted or otherwise filtered out of the first electroencephalography signal to improve a signal to noise ratio (SNR) of the first electroencephalography signal. In some implementations, identifying 1004 artifacts in the first electroencephalography signal based on the measurements from the contact microphone may include inputting measurement data from the contact sensor and/or features extracted from this measurement data in a analysis window, along with data derived from the first electroencephalography signal, to one or more machine learning models that are trained to generate predictions of an estimated brain state in the presence of such artifacts.

FIG. 11 is flowchart of an example of a technique 1100 for identifying artifacts in an electroencephalography signal caused by motion of an eartip using an accelerometer. The technique 1100 includes accessing 1102 measurements from an accelerometer; and identifying 1104 artifacts in the first electroencephalography signal caused by motion of the third electrode within the ear canal based on the measurements from the accelerometer. For example, technique 1100 may be implemented using the system 100 of FIGS. 1A-E. For example, technique 1100 may be implemented using the system 200 of FIGS. 2A-E. For example, technique 1100 may be implemented using the system 300 of FIGS. 3A-E. For example, technique 1100 may be implemented using the system 500 of FIGS. 5A-C. For example, technique 1100 may be implemented using the system 600 of FIG. 6A. For example, technique 1100 may be implemented using the system 630 of FIG. 6B.

The technique 1100 includes accessing 1102 measurements from an accelerometer. The accelerometer may be part of an earbud device (e.g., the earbud device 112, the earbud device 212, the earbud device 312, the earbud device 512 or the earbud device 640). For example, the measurements may be accessed 1102 by reading the measurements from the accelerometer via a bus (e.g., the bus 624). In some implementations, accessing 1102 measurements may include receiving the measurements via a communications link (e.g., the wireless communications link 650). For example, the measurements may be accessed 1102 via a wireless or wired communications interface (e.g., Wi-Fi, Bluetooth, USB, HDMI, Wireless USB, Near Field Communication (NFC), Ethernet, a radio frequency transceiver, and/or other interfaces). For example, the measurements may be accessed 1102 using communications interface 666.

The technique 1100 includes identifying 1104 artifacts in the first electroencephalography signal caused by motion of the third electrode within the ear canal based on the measurements from the accelerometer. The accelerometer measurements may reflect when an eartip on which the electrodes are positioned in is moved within the canal. This type of motion may cause transient changes in impedance between the electrodes and the skin of the ear canal. The measurements from the accelerometer may be analyzed to detect such a motion related event and to predict how an artifact of this event would manifest in the first electroencephalography signal. For example, identifying 1104 artifacts in the first electroencephalography signal may include passing a sequence of measurements from the accelerometer through a high-pass filter and comparing the output of the filter to threshold. Identifying 1104 such an artifact in the first electroencephalography signal may enable the artifact to be subtracted or otherwise filtered out of the first electroencephalography signal to improve a signal to noise ratio (SNR) of the first electroencephalography signal. In some implementations, identifying 1104 artifacts in the first electroencephalography signal based on the measurements from the accelerometer may include inputting measurement data from the accelerometer and/or features extracted from this measurement data in a analysis window, along with data derived from the first electroencephalography signal, to one or more machine learning models that are trained to generate predictions of an estimated brain state in the presence of such artifacts.

FIG. 12 is flowchart of an example of a technique 1200 for identifying artifacts in an electroencephalography signal caused by motion of an eartip using a gyroscope. The technique 1200 includes accessing 1202 measurements from a gyroscope; and identifying 1204 artifacts in the first electroencephalography signal caused by motion of the third electrode within the ear canal based on the measurements from the gyroscope. For example, technique 1200 may be implemented using the system 100 of FIGS. 1A-E. For example, technique 1200 may be implemented using the system 200 of FIGS. 2A-E. For example, technique 1200 may be implemented using the system 300 of FIGS. 3A-E. For example, technique 1200 may be implemented using the system 500 of FIGS. 5A-C. For example, technique 1200 may be implemented using the system 600 of FIG. 6A. For example, technique 1200 may be implemented using the system 630 of FIG. 6B.

The technique 1200 includes accessing 1202 measurements from a gyroscope. The gyroscope may be part of an earbud device (e.g., the earbud device 112, the earbud device 212, the earbud device 312, the earbud device 512 or the earbud device 640). For example, the measurements may be accessed 1202 by reading the measurements from the gyroscope via a bus (e.g., the bus 624). In some implementations, accessing 1202 measurements may include receiving the measurements via a communications link (e.g., the wireless communications link 650). For example, the measurements may be accessed 1202 via a wireless or wired communications interface (e.g., Wi-Fi, Bluetooth, USB, HDMI, Wireless USB, Near Field Communication (NFC), Ethernet, a radio frequency transceiver, and/or other interfaces). For example, the measurements may be accessed 1202 using communications interface 666.

The technique 1200 includes identifying 1204 artifacts in the first electroencephalography signal caused by motion of the third electrode within the ear canal based on the measurements from the gyroscope. The gyroscope measurements may reflect when an eartip on which the electrodes are positioned in is moved within the canal. This type of motion may cause transient changes in impedance between the electrodes and the skin of the ear canal. The measurements from the gyroscope may be analyzed to detect such a motion related event and to predict how an artifact of this event would manifest in the first electroencephalography signal. For example, identifying 1204 artifacts in the first electroencephalography signal may include passing a sequence of measurements from the gyroscope through a high-pass filter and comparing the output of the filter to threshold. Identifying 1204 such an artifact in the first electroencephalography signal may enable the artifact to be subtracted or otherwise filtered out of the first electroencephalography signal to improve a signal to noise ratio (SNR) of the first electroencephalography signal. In some implementations, identifying 1204 artifacts in the first electroencephalography signal based on the measurements from the gyroscope may include inputting measurement data from the gyroscope and/or features extracted from this measurement data in a analysis window, along with data derived from the first electroencephalography signal, to one or more machine learning models that are trained to generate predictions of an estimated brain state in the presence of such artifacts.

FIG. 13 is a signal flow diagram of an example of a signal flow 1300 in an in-ear brain-computer interface. The measurements of electrical potential are collected at a set of electrodes, including a first electrode 1302, a second electrode 1304, a third electrode 1306, and an Nth electrode 1308. The first electrode 1302, the second electrode 1304, and the third electrode are positioned in an ear canal, in contact with skin of the ear canal. In some implementations, all of the electrodes are positioned inside of the ear canal. In some implementations, one or more additional electrodes (e.g., the Nth electrode 1308) are located inside a second ear canal of the user. In some implementations, one or more additional electrodes (e.g., the Nth electrode 1308) are located elsewhere on the user's body, in contact with the user's skin outside of the ear canals. These electrodes may be used to collect one or more channels of electroencephalography data that may include electromagnetic signals from a brain of the user. The first electrode 1302 may be used as a common reference electrode. The second electrode 1304 may be used as a ground/driven right leg (DRL) electrode. The third electrode 1306 may be used as a first electroencephalography channel electrode, and the Nth electrode 1308 may be used as an additional electroencephalography channel electrode.

The voltages at the electrodes are amplified using respective operational amplifiers 1312, 1314, 1316, and 1318. The amplified voltages output from the operational amplifiers 1312, 1314, 1316, and 1318 are input to respective analog-to-digital converters 1322, 1324, 1326, and 1328 to obtain digital signals including sequences of measurements from the electrodes 1302, 1304, 1306, and 1308.

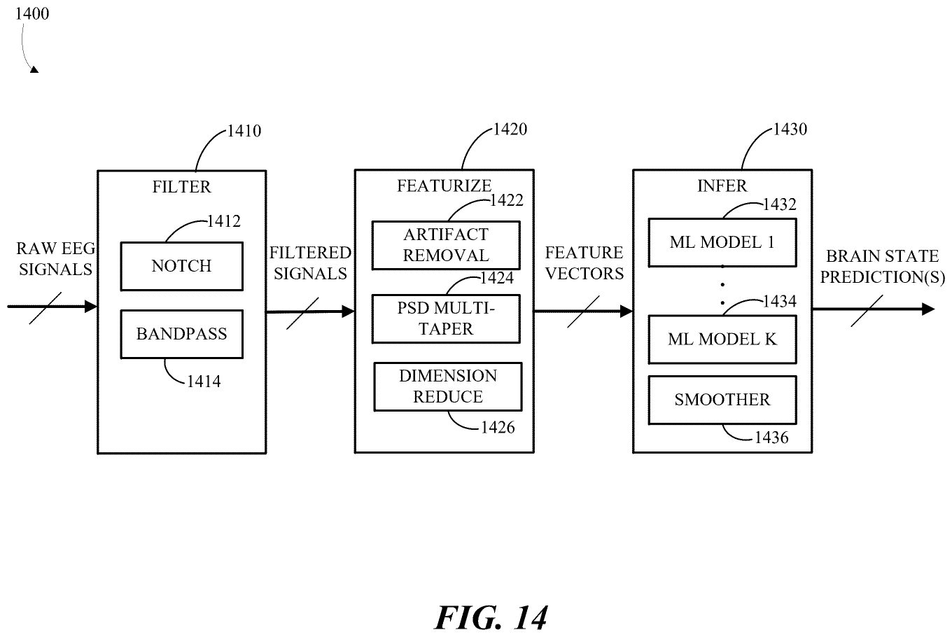

These digital signals from the analog-to-digital converters 1322, 1324, 1326, and 1328 are then input to an electroencephalography signal processing pipeline 1330, which is configured to analyze the digital signals from the electrodes and determine an estimate of brain state based, at least in part, on these digital signals. For example, the electroencephalography signal processing pipeline 1330 may determine a first channel of electroencephalography data by subtracting voltage measurements of the first electrode 1302 from voltage measurements of the third electrode 1306 to obtain a first electroencephalography signal. The electroencephalography signal processing pipeline 1330 may be configured to estimate a brain state based on one or more of these electroencephalography signals. For example, the electroencephalography signal processing pipeline 1330 may be configured to perform power spectral density analysis of a set of one or more electroencephalography signals derived from the measurement data from the electrodes 1302, 1304, 1306, 1308. In some implementations, the electroencephalography signal processing pipeline 1330 includes one or more machine learning models that have been trained to map electroencephalography signal(s) in a window of time (e.g., a 1 second or a 2 second window) and/or features derived from the electroencephalography signal(s) to one or more predictions that are correlated with aspects of a brain state (e.g., a level of focus, a level of attentiveness, a level of cognitive load, fatigue, or sleepiness). For example, the electroencephalography signal processing pipeline 1330 may periodically output a vector of brain state parameters, including features derived from the electroencephalography signal(s) (e.g., alpha wave power, beta wave power, gamma wave power, delta wave power, and/or theta wave power) and/or predictions from machine learning models. For example, the electroencephalography signal processing pipeline 1330 may include the electroencephalography signal processing pipeline 1400 of FIG. 14.

A driven-right-leg (DRL) circuitry 1340 may also be connected to the second electrode 1304 and configured to drive a DRL voltage signal to the skin in the ear canal via the second electrode 1304 to suppress common mode noise in the voltage signals from the other electrodes. For example, the DRL circuitry 1340 may include an inverting amplifier configured to detect the common voltage between the first electrode 1302 and the third electrode 1306, invert the common voltage, and the add it back to the ear canal via the second electrode 1304 to suppress common mode noise in the measurements used to determine the one or more electroencephalography signals.

FIG. 14 is a signal flow diagram of an example of an electroencephalography signal processing pipeline 1400 in an in-ear brain-computer interface. The electroencephalography signal processing pipeline 1400 includes a filter stage 1410, a featurize stage 1420, and an infer stage 1430. The electroencephalography signal processing pipeline 1400 receives one or more raw electroencephalography signals and inputs them to the filter stage 1410. The filter stage 1410 includes a notch filter 1412 and a bandpass filter 1414 that may be used to suppress noise (e.g., 50 Hz or 60 Hz noise from power lines) in the raw electroencephalography signals to generate filtered signals with higher signal-to-noise ratio (SNR).

The filtered signals are output from the filter stage 1410 and input to the featurize stage 1420. The featurize stage 1420 includes an artifact removal module 1422, a power spectral density multi-taper module 1424, and a dimension reduce module 1426. The artifact removal module 1422 may be configured to identify artifacts in the filtered signals based on out-of-band data (not shown explicitly in FIG. 14) that is synchronized with the filtered signals. For example, this out-of-band data may include measurements from a contact microphone, an accelerometer, and/or a gyroscope positioned near the one or more of the electrodes (e.g., in the earbud device 512). This out-of-band data may reflect motion of one or more of the electrodes (e.g., including the third electrode 1306) within the ear canal, which may cause transient changes in impedance between the electrodes and the skin the ear canal, resulting in artifacts in the filter signals that may be predicted and removed by the artifact removal module 1422.

The featurize stage 1420 includes a power spectral density multi-taper module 1424 that is configured to perform a power spectral density analysis (e.g., using a Fast Fourier Transform (FFT)) of the filtered signals to determine a set of features of the signals. For example, the set of features determined by the power spectral density multi-taper module 1424 may include power in the alpha (8-12 Hz), beta (12-30 Hz), theta (4-8 Hz), gamma (30-100 Hz), and/or Delta (1-4 Hz) frequency ranges for each of the one or more filtered electroencephalography signals.

The featurize stage 1420 includes a dimension reduce module 1426 that is configured to perform a dimension reduction operation (e.g., a linear mapping based on a principle components analysis) to map a set of features from the power spectral density multi-taper module 1424 and/or additional features extracted from the filtered signals to a smaller vector of features that has higher entropy per element. The resulting vector of features may be output from the featurize stage 1420.

The vector of features output from the featurize stage 1420 is input to the infer stage 1430. The infer stage 1430 includes one or more machine learning models, including a first machine learning model 1432 and a Kth machine learning model 1434 that are trained to generate predictions based on a vector of features from the featurize stage 1420. As a result of the training of these models, the predictions may be correlated with aspects of a brain state, such as, for example, a level of focus, a level of attentiveness, a level of cognitive load, fatigue, and/or sleepiness. The infer stage 1430 includes a smoother module 1436 that is configured to apply low-pass filtering to a sequence of predictions from on the machine learning models (e.g., the first machine learning model 1432). The set of predictions, with or without smoothing, may then be output from the infer stage 1430 as vector of brain state predictions. The vector of brain state predictions may serve as an estimate of a brain state. In some implementations, an estimate of the brain state output from the electroencephalography signal processing pipeline 1400 includes both the vector of brain state predictions and a corresponding vector of features from the featurize stage 1420.

In some implementations, signal quality metrics, called p_bad values, associated with the DRL and REF channels may be estimated and used to evaluate the quality of electroencephalography signals determined based on the reference signal and the voltage at the DRL electrode. An overall p_bad for DRL and REF, p_bad_drl_ref may be defined as the logical OR of several specific p_bad measures:
p_bad_drl_ref=p_bad_drl|p_bad_ref|p_bad_drl_ref_difference
   where Here, the | symbol represents logical OR. For example, these composite pbad measures may be defined as follows:
drl_fract_outside_range=((drl_epoch<min_drl_acceptable)|(drl_epoch>max_drl_acceptable)).mean( )
pbad_drl=drl_fract_outside_range>0.125
   and
ref_fract_outside_range=((ref_epoch<min_ref_acceptable)|(ref_epoch>max_ref_acceptable) ).mean( )>0.125
pbad_ref=ref_fract_outside_range>0.125
   These criteria enforce that, for each time window involved in processing, DRL and REF must spend at least 87.5 % of the time between the min and max acceptable bounds. For example, these values are defined as follows:
min_ref_acceptable=min_drl_acceptable=1000
max_ref_acceptable=max_drl_acceptable=3000

### Lastly,

drl_ref_difference_fract_outside_range=((abs(ref_epoch-drl_epoch)>ref_drl_max_distance).mean( )
pbad_drl_ref_difference=drl_ref_difference_fract_outside_range>0.125 enforces that DRL and REF cannot be more than ref_drl_max_distance apart for 12.5 % of the epoch. For example, ref_drl_max_distance may be set equal to 1000.

For example, p_bad_drl_ref may be used to selectively disable or suppress electroencephalography signals in windows of time that have been determined based on the reference signal and the voltage at the DRL electrode that are found to be noisy or low quality.

In a first aspect, the subject matter described in this specification can be embodied in systems that include: an eartip shaped for insertion in an ear canal, a first electrode positioned on an outer surface of the eartip, a second electrode positioned on an outer surface of the eartip, a third electrode positioned on an outer surface of the eartip, and a processing apparatus configured to: access measurements of electrical potential of the first electrode, the second electrode, and the third electrode; determine a reference signal based on measurements of electrical potential of the first electrode; determine a ground signal based on measurements of electrical potential of the second electrode; determine a first electroencephalography signal based on measurements of electrical potential of the third electrode and based on the reference signal; and estimate a brain state based on the first electroencephalography signal. In the first aspect, the systems may include circuity configured to: drive a driven right leg (DRL) voltage to the second electrode to suppress common mode noise in the first electroencephalography signal. In the first aspect, the first electrode, the second electrode, and the third electrode may extend laterally along the eartip from an anterior end of the eartip that will be inserted deepest into the ear canal to a posterior end of the eartip. In the first aspect, the third electrode may fit entirely inside the ear canal. In the first aspect, the eartip may have a cylindrical outer surface and the first electrode, the second electrode, and the third electrode may be positioned around the cylindrical outer surface with strips of insulator on the cylindrical outer surface separating the first electrode, the second electrode, and the third electrode. In the first aspect, an outer surface of the eartip may have an oval cross section perpendicular to axis of insertion into the ear canal. In the first aspect, the systems may include a fourth electrode positioned on an outer surface of the eartip, and the processing apparatus may be configured to: access measurements of electrical potential of the fourth electrode; determine a second electroencephalography signal based on measurements of electrical potential of the fourth electrode and based on the reference signal; and estimate the brain state based on the second electroencephalography signal. In the first aspect, the systems may include a contact microphone positioned near an anterior end of the eartip, and the processing apparatus may be configured to: access measurements from the contact microphone; and identify artifacts in the first electroencephalography signal caused by motion of the eartip within the ear canal based on the measurements from the contact microphone. In the first aspect, the systems may include an accelerometer connected to the eartip, and the processing apparatus may be configured to: access measurements from the accelerometer; and identify artifacts in the first electroencephalography signal caused by motion of the eartip within the ear canal based on the measurements from the accelerometer. In the first aspect, the systems may include a gyroscope connected to the eartip, and the processing apparatus may be configured to: access measurements from the gyroscope; and identify artifacts in the first electroencephalography signal caused by motion of the eartip within the ear canal based on the measurements from the gyroscope. In the first aspect, the eartip may be removably attached to an earbud device using a mechanical interface that includes a rotation locking mechanism configured to prevent rotation of the eartip about an axis of insertion into the ear canal. In the first aspect, the eartip may be attached to an earbud device that includes a speaker. In the first aspect, all electrodes on outer surfaces of the earbud device may be positioned on the eartip to fit within the ear canal. In the first aspect, the earbud device may include an array of microphones configured for use with the speaker to cancel noise. In the first aspect, the third electrode may be connected to the processing apparatus via one or more conductors connected in series. In the first aspect, the processing apparatus may receive the measurements of electrical potential of the third electrode via a wireless communications link.

In a second aspect, the subject matter described in this specification can be embodied in methods that include accessing measurements of electrical potential of a first electrode, a second electrode, and a third electrode that are in contact with an inside surface of an ear canal; determining a reference signal based on measurements of electrical potential of the first electrode; determining a ground signal based on measurements of electrical potential of the second electrode; determining a first electroencephalography signal based on measurements of electrical potential of the third electrode and based on the reference signal; estimating a brain state based on the first electroencephalography signal; and storing, displaying, or transmitting an indication of the estimated brain state. In the second aspect, the methods may include driving a driven right leg (DRL) voltage to the second electrode to suppress common mode noise in the first electroencephalography signal. In the second aspect, accessing measurements of electrical potential of the third electrode may include receiving the measurements of electrical potential of the third electrode via a wireless communications link. In the second aspect, accessing measurements of electrical potential of the third electrode may include sampling the electrical potential of a conductor connected to the third electrode. In the second aspect, the methods may include accessing measurements of electrical potential of a fourth electrode that is in contact with the inside surface of the ear canal; determining a second electroencephalography signal based on measurements of electrical potential of the fourth electrode and based on the reference signal; and estimating the brain state based on the second electroencephalography signal. In the second aspect, the methods may include accessing measurements from a contact microphone; and identifying artifacts in the first electroencephalography signal caused by motion of the third electrode within the ear canal based on the measurements from the contact microphone. In the second aspect, the methods may include accessing measurements from an accelerometer; and identifying artifacts in the first electroencephalography signal caused by motion of the third electrode within the ear canal based on the measurements from the accelerometer. In the second aspect, the methods may include accessing measurements from a gyroscope; and identifying artifacts in the first electroencephalography signal caused by motion of the third electrode within the ear canal based on the measurements from the gyroscope.

In a third aspect, the subject matter described in this specification can be embodied in systems that include: a means for positioning a first electrode, a second electrode and a third electrode in contact with an inside surface of an ear canal, and a processing apparatus configured to: access measurements of electrical potential of the first electrode, the second electrode, and the third electrode; determine a reference signal based on measurements of electrical potential of the first electrode; determine a ground signal based on measurements of electrical potential of the second electrode; determine a first electroencephalography signal based on measurements of electrical potential of the third electrode and based on the reference signal; and estimate a brain state based on the first electroencephalography signal. In the third aspect, the systems may include circuity configured to drive a driven right leg (DRL) voltage to the second electrode to suppress common mode noise in the first electroencephalography signal. In the third aspect, the third electrode may fit entirely inside the ear canal. In the third aspect, the systems may include a fourth electrode that is positioned in contact with the inside surface of the ear canal, and the processing apparatus may be configured to: access measurements of electrical potential of the fourth electrode; determine a second electroencephalography signal based on measurements of electrical potential of the fourth electrode and based on the reference signal; and estimate the brain state based on the second electroencephalography signal. In the third aspect, the systems may include a contact microphone positioned near the third electrode, and the processing apparatus may be configured to: access measurements from the contact microphone; and identify artifacts in the first electroencephalography signal caused by motion of the third electrode within the ear canal based on the measurements from the contact microphone. In the third aspect, the systems may include an accelerometer connected to the third electrode, and the processing apparatus may be configured to: access measurements from the accelerometer; and identify artifacts in the first electroencephalography signal caused by motion of the third electrode within the ear canal based on the measurements from the accelerometer. In the third aspect, the systems may include a gyroscope connected to the third electrode, and the processing apparatus may be configured to: access measurements from the gyroscope; and identify artifacts in the first electroencephalography signal caused by motion of the third electrode within the ear canal based on the measurements from the gyroscope. In the third aspect, the third electrode may be connected to the processing apparatus via one or more conductors connected in series. In the third aspect, the processing apparatus may receive the measurements of electrical potential of the third electrode via a wireless communications link.

In a fourth aspect, the subject matter described in this specification can be embodied in a non-transitory computer-readable storage medium. The non-transitory computer-readable storage medium includes executable instructions that, when executed by a processor, cause performance of operations, comprising operations to: accessing measurements of electrical potential of a first electrode, a second electrode, and a third electrode that are in contact with an inside surface of an ear canal; determining a reference signal based on measurements of electrical potential of the first electrode; determining a ground signal based on measurements of electrical potential of the second electrode; determining a first electroencephalography signal based on measurements of electrical potential of the third electrode and based on the reference signal; estimating a brain state based on the first electroencephalography signal; and storing, displaying, or transmitting an indication of the estimated brain state. In the fourth aspect, the operations may include operations to drive a driven right leg (DRL) voltage to the second electrode to suppress common mode noise in the first electroencephalography signal. In the fourth aspect, accessing measurements of electrical potential of the third electrode may include receiving the measurements of electrical potential of the third electrode via a wireless communications link. In the fourth aspect, accessing measurements of electrical potential of the third electrode may include sampling the electrical potential of a conductor connected to the third electrode. In the fourth aspect, the operations may include operations to: access measurements of electrical potential of a fourth electrode that is in contact with the inside surface of the ear canal; determine a second electroencephalography signal based on measurements of electrical potential of the fourth electrode and based on the reference signal; and estimate the brain state based on the second electroencephalography signal. In the fourth aspect, the operations may include operations to: access measurements from a contact microphone; and identify artifacts in the first electroencephalography signal caused by motion of the third electrode within the ear canal based on the measurements from the contact microphone. In the fourth aspect, the operations may include operations to: access measurements from an accelerometer; and identify artifacts in the first electroencephalography signal caused by motion of the third electrode within the ear canal based on the measurements from the accelerometer. In the fourth aspect, the operations may include operations to: access measurements from a gyroscope; and identify artifacts in the first electroencephalography signal caused by motion of the third electrode within the ear canal based on the measurements from the gyroscope.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures.

What is claimed is:

1. A system comprising:
an eartip shaped for insertion in an ear canal,
a first electrode positioned on an outer surface of the eartip,
a second electrode positioned on an outer surface of the eartip,
a third electrode positioned on an outer surface of the eartip, and
a processing apparatus configured to:
access measurements of electrical potential of the first electrode, the second electrode, and the third electrode;
determine a reference signal based on measurements of electrical potential of the first electrode;
determine a ground signal based on measurements of electrical potential of the second electrode;
determine a first electroencephalography signal based on measurements of electrical potential of the third electrode and based on the reference signal; and
estimate a brain state based on the first electroencephalography signal.

2. The system of claim 1, comprising circuity configured to:
drive a driven right leg (DRL) voltage to the second electrode to suppress common mode noise in the first electroencephalography signal.

3. The system of claim 1, in which the first electrode, the second electrode, and the third electrode extend laterally along the eartip from an anterior end of the eartip that will be inserted deepest into the ear canal to a posterior end of the eartip.

4. The system of claim 3, in which the third electrode fits entirely inside the ear canal.

5. The system of claim 1, in which the eartip has a cylindrical outer surface and the first electrode, the second electrode, and the third electrode are positioned around the cylindrical outer surface with strips of insulator on the cylindrical outer surface separating the first electrode, the second electrode, and the third electrode.

6. The system of claim 1, in which an outer surface of the eartip has an oval cross section perpendicular to axis of insertion into the ear canal.

7. The system of claim 1, comprising a fourth electrode positioned on an outer surface of the eartip, and in which the processing apparatus is configured to:
access measurements of electrical potential of the fourth electrode;
determine a second electroencephalography signal based on measurements of electrical potential of the fourth electrode and based on the reference signal; and
estimate the brain state based on the second electroencephalography signal.

8. The system of claim 1, comprising a contact microphone positioned near an anterior end of the eartip, and in which the processing apparatus is configured to:
access measurements from the contact microphone; and
identify artifacts in the first electroencephalography signal caused by motion of the eartip within the ear canal based on the measurements from the contact microphone.

9. The system of claim 1, comprising an accelerometer connected to the eartip, and in which the processing apparatus is configured to:
access measurements from the accelerometer; and
identify artifacts in the first electroencephalography signal caused by motion of the eartip within the ear canal based on the measurements from the accelerometer.

10. The system of claim 1, comprising a gyroscope connected to the eartip, and in which the processing apparatus is configured to:
access measurements from the gyroscope; and
identify artifacts in the first electroencephalography signal caused by motion of the eartip within the ear canal based on the measurements from the gyroscope.

11. The system of claim 1, in which the eartip is removably attached to an earbud device using a mechanical interface that includes a rotation locking mechanism configured to prevent rotation of the eartip about an axis of insertion into the ear canal.

12. The system of claim 1, in which the eartip is attached to an earbud device that includes a speaker.

13. The system of claim 12, in which all electrodes on outer surfaces of the earbud device are positioned on the eartip to fit within the ear canal.

14. The system of claim 12, in which the earbud device includes an array of microphones configured for use with the speaker to cancel noise.

15. The system of claim 1, in which the third electrode is connected to the processing apparatus via one or more conductors connected in series.

16. The system of claim 1, in which the processing apparatus receives the measurements of electrical potential of the third electrode via a wireless communications link.

17. A method comprising:
accessing measurements of electrical potential of a first electrode, a second electrode, and a third electrode that are in contact with an inside surface of an ear canal;
determining a reference signal based on measurements of electrical potential of the first electrode;
determining a ground signal based on measurements of electrical potential of the second electrode;
determining a first electroencephalography signal based on measurements of electrical potential of the third electrode and based on the reference signal;
estimating a brain state based on the first electroencephalography signal; and
storing, displaying, or transmitting an indication of the estimated brain state.

18. The method of claim 17, comprising:
driving a driven right leg (DRL) voltage to the second electrode to suppress common mode noise in the first electroencephalography signal.

19. The method of claim 17, comprising:
accessing measurements of electrical potential of a fourth electrode that is in contact with the inside surface of the ear canal;
determining a second electroencephalography signal based on measurements of electrical potential of the fourth electrode and based on the reference signal; and
estimating the brain state based on the second electroencephalography signal.

20. A system comprising:
a means for positioning a first electrode, a second electrode and a third electrode in contact with an inside surface of an ear canal; and
a processing apparatus configured to:
access measurements of electrical potential of the first electrode, the second electrode, and the third electrode;
determine a reference signal based on measurements of electrical potential of the first electrode;
determine a ground signal based on measurements of electrical potential of the second electrode;
determine a first electroencephalography signal based on measurements of electrical potential of the third electrode and based on the reference signal; and
estimate a brain state based on the first electroencephalography signal.
